(19) United States
(12) Patent Application Publication
(10) Pub. No.: US 2023/0380359 A1
(43) Pub. Date: Nov. 30, 2023

(54) SYSTEMS AND METHODS FOR HYDROPONIC PLANT CULTIVATION

(71) Applicant: Revol Greens GBC, Owantonna, MN (US)

(72) Inventors: Marcus Arthur Robert Carolus VERGELDT, Lottum (NL); Steven Lee AMUNDSON, Medford, MN (US); Tyler Ward BERGENE, Blooming Prairie, MN (US); Bentley MILLS, Bishop, GA (US)

(21) Appl. No.: 18/231,544

(22) Filed: Aug. 8, 2023

Related U.S. Application Data
(63) Continuation of application No. PCT/US2022/016575, filed on Feb. 16, 2022.
(60) Provisional application No. 63/150,464, filed on Feb. 17, 2021.

(51) Int. Cl. A01G 31/02; A01G 29/00; A01G 27/00

(52) U.S. Cl. CPC A01G 31/02; A01G 29/00; A01G 27/003; A01G 2031/006

(57) ABSTRACT

Systems and methods for hydroponic plant cultivation are disclosed herein. The systems can include a water management unit, a bioreactor, and one or more plant growth regions. Plants may be cultivated on floats disposed in the one or more plant growth regions. The bioreactor can include a substrate upon which one or more of bacteria, fungi, and/or other microorganisms can reside. A nitrogen feed source can be delivered to the bioreactor where it is converted into nitrates via a nitrification process. Plasma activated water can also be added to the system.

### CROSS-REFERENCE TO RELATED APPLICATIONS

This application is a by-pass continuation of International Patent Application Number PCT/US2022/016575, filed Feb. 16, 2022, which claims priority to U.S. Patent Application Ser. No. 63/150,464, filed Feb. 17, 2021, both of which are hereby incorporated by reference herein in their entireties.

### TECHNICAL FIELD

The present disclosure relates to systems and methods for hydroponic plant cultivation. More specifically, aspects of the present disclosure relate to systems and methods for organic hydroponic plant cultivation.

### BACKGROUND

Hydroponic plant cultivation holds many advantages over growing food in soil, including, but not limited to, water efficiency and improvements in growth cycles. Hydroponics, generally speaking, is a method of growing plants in a water-based, nutrient rich solution. Hydroponics does not require the use of soil as a growing medium soil, and instead the root system is can be supported using an inert medium such as perlite, rock wool, clay pellets, peat moss, or vermiculite. Hydroponic growing methods generally allow the plants' roots to come in direct contact with the nutrient solution, while also having access to oxygen, which is essential for proper growth.

According to certain aspects, hydroponic plant cultivation can be carried out through careful control of the nutrient solution and pH levels. Certain hydroponic systems use less water than soil based plants because the system can be enclosed, which may result in less evaporation. In addition, hydroponic cultivation may be capable of growing food with fewer chemical fertilizers to replenish the necessary nutrients plants require from soil. Hydroponic growing methods are often also better for the environment than traditional soil-based growing methods, because hydroponic systems may be capable of reducing waste and pollution from soil runoff. In contrast, in traditional flood irrigation a significant percentage of water applied to a field is lost, either through evaporation to the air or migration below the effective root zone of the plants. The downward migration of water also has the negative consequence of carrying fertilizers, pesticides and insecticides into the groundwater.

The efficiencies seen with certain hydroponic systems may also carry over to the efficient use of acreage, as the same plot of land used to grow plants in soil can typically be used to grow a greater number of plants hydroponically. Certain hydroponic systems can also provide an increased rate of growth of plants. For example, with the proper setup, certain hydroponic systems can provide for plants that can mature up to 25% faster and produce up to 30% more than the same plants grown in soil. In certain hydroponic systems, plants can grow bigger and faster because they will not have to work as hard to obtain nutrients. Accordingly, in certain aspects, a fine-tuned hydroponic system can surpass a soil based system in plant quality and amount of produce yielded, making such systems desirable for the growing and cultivation of commercial crops.

However, despite the improvements in efficiency there remain problems with cultivating plants hydroponically, including in providing efficient systems for the healthy and rapid growth of various types of plants. The present application seeks to address these issues.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 is a schematic illustration of a system for treating water for use in hydroponic plant cultivation.

FIG. 2 is a schematic illustration of a system for hydroponic plant cultivation.

FIG. 3 is a schematic illustration of another embodiment of a system for hydroponic plant cultivation.

FIG. 4 is a cross-sectional perspective of another embodiment of a system for hydroponic plant cultivation.

FIG. 5 is a cross-sectional perspective of another embodiment of a system for hydroponic plant cultivation.

FIG. 6 is a cross-sectional perspective of another embodiment of a system for hydroponic plant cultivation.

FIG. 7 is a schematic illustration of another embodiment of a system for hydroponic plant cultivation.

### DETAILED DESCRIPTION

The present disclosure relates to systems and methods for hydroponic plant cultivation. More specifically, the present disclosure relates to systems and methods for organic hydroponic plant cultivation. As set forth below, various types of hydroponic plant cultivation are contemplated and can be used in accordance with principles of this disclosure, including, but not limited to, aeroponic hydroponic systems, deep water hydroponic systems, aquaponic hydroponic systems, N.F.T. (nutrient film technology) hydroponic systems, rolling bench or rolling container/gutter hydroponic systems, and tabletop hydroponic systems. Other types of hydroponic plant cultivation techniques can also be used in accordance with the principles disclosed herein.

Hydroponic plant cultivation techniques often involve growing plants in water rather than in soil or in the ground. While hydroponic plant cultivation techniques offer many advantages over soil or in ground plant cultivation, there can be significant challenges associated with these growing techniques. For instance, one challenge associated with some hydroponic plant cultivation techniques is the lack of sufficient amounts of bacteria, fungi and/or other microorganisms that help to process an organic fertilizer into forms that are available for uptake by the plants. As can be appreciated, organic fertilizers do not typically contain nitrogen in a bioavailable form but instead contain nitrogen compounds, such as proteins and/or amino acids, that can be converted into usable nitrogen compounds by an ammonification and/or nitrification process.

Another challenge often associated with some hydroponic plant cultivation techniques is the lack of oxygen present in the water. For instance, the oxygen levels found in soil or in ground cultivation techniques are typically at least 5 to 300 times greater than the oxygen levels found in hydroponic cultivation techniques. Further, air pockets and/or channels throughout the soil can allow a constant flow of oxygen to the roots of the plant. In hydroponic plant cultivation techniques, the water commonly contains between 0 mg/L and about 10 mg/L of oxygen. This oxygen level is also constantly decreasing as the oxygen is being utilized by the plants, resulting in the need to constantly add oxygen to the system.

The present disclosure relates to systems and methods that address these and other challenges associated with hydroponic plant cultivation techniques. The disclosed systems and methods can be particularly useful in the cultivation of organic plants.

It will be readily understood by one of skill in the art having the benefit of this disclosure that the components of the embodiments as generally described and illustrated in the figures herein could be arranged and designed in a wide variety of different configurations. Thus, the following more detailed description of various embodiments, as represented in the figures, is not intended to limit the scope of the present disclosure, but is merely representative of various embodiments. While various aspects of the embodiments are presented in drawings, the drawings are not necessarily drawn to scale unless specifically indicated.

The phrase “fluid communication” is used in its ordinary sense, and is broad enough to refer to arrangements in which a fluid (e.g., a gas or a liquid) can flow from one element to another element when the elements are in fluid communication with each other. The phrase “coupled to” is used in its ordinary sense, and is broad enough to refer to any suitable coupling or other form of interaction between two or more entities, including mechanical, fluid, and thermal interaction. Two components may be coupled to each other even though they are not in direct contact with each other. For example, two components may be coupled to each other through an intermediate component.

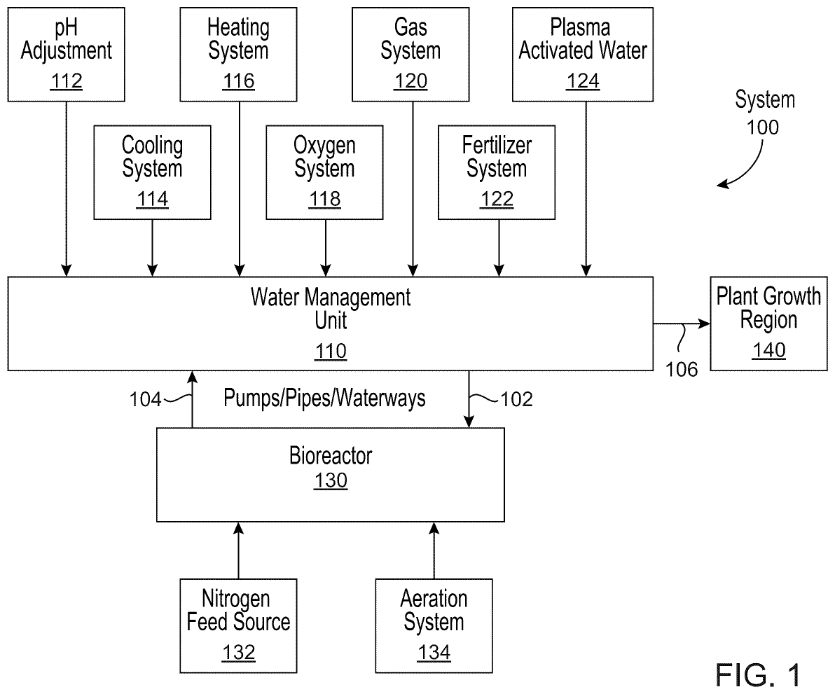

FIG. 1 is a schematic illustration of a system 100 for use in hydroponic plant cultivation in accordance with an embodiment of the present disclosure. More specifically, FIG. 1 illustrates a system 100 for treating and/or preparing water that can be delivered to plants in one or more plant growth regions 140. The one or more plant growth regions 140 can utilize various hydroponic plant cultivation techniques, as further detailed below.

As shown in FIG. 1, the system 100 includes a water management unit 110 and a bioreactor 130 that are in fluid communication with each other such that water can be circulated throughout the system 100. For instance, as shown in FIG. 1, water can be circulated through the system 100 via conduits such as pumps, pipes, and/or waterways represented by the directional arrows 102, 104, and 106. These conduits, represented in system 100 can take any form of connection that allows for the flow of liquid. In the illustrated embodiment, water is circulated from the water management unit 110 to the bioreactor 130, and from the bioreactor 130 back to the water management unit 110. One or more additional components may be added to the system 100 as needed to control and/or modify one or more parameters of the water. Treated water can also be delivered from the water management unit 110 to a plant growth region 140 as further detailed below.

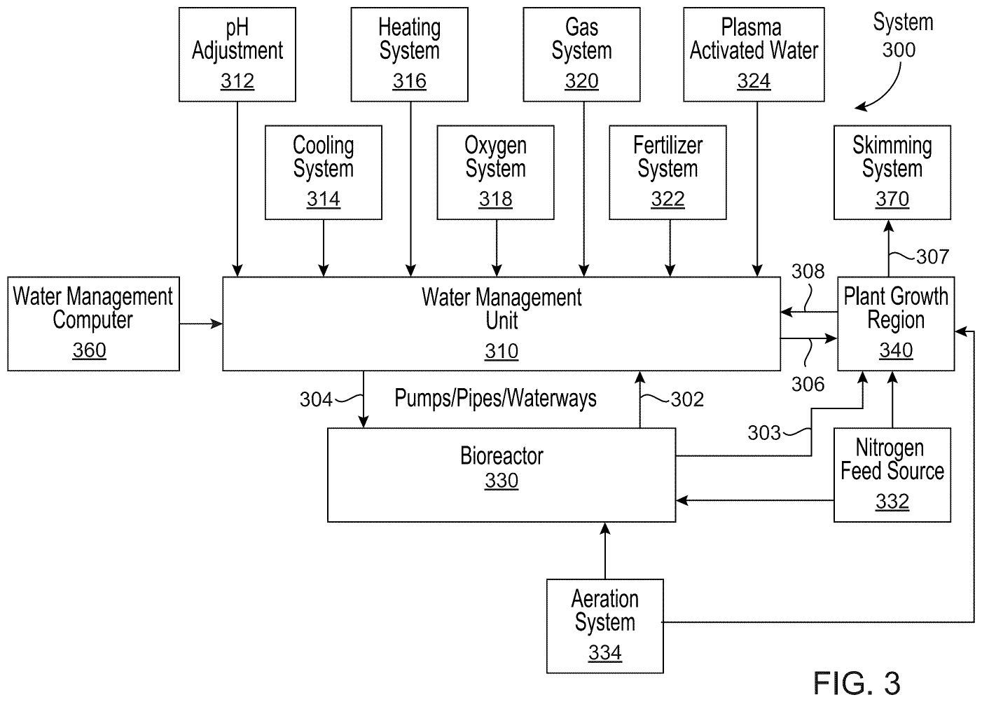

According to certain aspects, the water management unit 110 is configured to treat water in the system. According to certain another aspects, the water management unit 100 can be configured to control the flow and/or circulation of water through the system. In certain embodiments, the water management unit 110 is in fluid communication with the plant growth regions 140 and in some embodiments with the bioreactor 130. As will be discussed with reference to FIG. 3, in some embodiments the bioreactor 330 is directly in fluid communication with the plant growth region 340. In other embodiments, the bioreactor 340 is in direct fluid communication with both the plant growth region 340 and the water management unit 310. Additional embodiments of the configuration of each of these components will be discussed in more detail below.

According to some embodiments, the water management unit 110 can be configured to control and/or modify one or more parameters of the water flowing through the system 100. In further embodiments, the bioreactor 130 can also be configured to control and/or modify one or more parameters of the water flowing through the system 100. As will be discussed in more detail below, non-limiting examples of these parameters include pH, temperature, oxygen level, nutrient level, oxygen reduction potential, light transmission, adenosine triphosphate (ATP), and specific ion conditions. According to certain embodiments, these one or more parameters of the water can be measured, and the one or more parameters can be adjusted if the one or more parameters exceed predetermined levels for that parameter as water circulates through the system. In some embodiments, the water management unit comprises sensors is configured to conduct these measurements, and is capable of making adjustments. According to other embodiments, the system comprises sensors to measure the parameters throughout other parts of the system. In some embodiments, this system comprises a controller, such as a computer, that is capable of automatically making measurements and setting adjustment parameters. For example, in some embodiments, any generalized computer, such as a handheld device, can be configured to operably link with the water management unit to provide automated measurements or adjustments. In some embodiments, the controller may also alert a user to perform adjustments of any one of the plurality of parameters in response to a change in the measurement of the parameter beyond a predetermined level.

In some embodiments, water is constantly and/or continuously circulated between the water management unit 110 and the bioreactor 130. In other embodiments, water is intermittently circulated between the water management unit 110 and the bioreactor 130. For instance, flow between the water management unit 110 and the bioreactor 130 can be turned on and/or off as desired or at preselected time intervals.

As is depicted in FIG. 3, in some embodiments the flow of water through the system is controlled with a water management computer 360 that is operable linked to the water management unit 310. The water management computer 360 is configured to control pumps, valves, and other means of controlling the flow of water through the system. In some embodiments the water management computer 360 controls the flow of water through the fluid conduits 302, 304, 306, 307, and 309. In some embodiments the water management computer 360 will control the flow of water through the skimming system 308.

In certain embodiments, as depicted in FIG. 1 the bioreactor 130 is configured to convert a nitrogen feed source 132 into nitrates available for plant uptake via one or more of an ammonification and/or a nitrification process. In some embodiments, the nitrogen feed source 132 can be organic and can comprise any variety of proteins, amino acids, ammonium, urea, organic acid, and/or any other organic molecule that can be digested and converted into nitrate via an ammonification and/or nitrification process. In some embodiments, the nitrogen feed source 132 comprises one or more of a plant based nitrogen source, an animal based nitrogen source, or an artificially created nitrogen source. In some embodiments, the plant based nitrogen source or plant based feed source is hydrolyzed, such as for example a hydrolyzed plant material from a waste stream generated by sugar production, horticultural plant waste, grass waste, or other organic plant material waste stream. In certain embodiments, the nitrogen feed source 132 comprises a plant based nitrogen source that comprises less than 10% by weight, less than 5% by weight, and even less than 1% by weight of any animal based nitrogen source or other material obtained or derived from animals.

As shown in FIG. 1, the nitrogen feed source 132 can be delivered into the bioreactor 130 where it is converted into nitrogen compounds that can be delivered to and used by the plants as a fertilizer. In some embodiments, the nitrogen feed source 132 is continuously delivered into the bioreactor 130. In other embodiments, the nitrogen feed source 132 is delivered into the bioreactor 130 intermittently or in batches. For instance, the nitrogen feed source 132 can be delivered into the bioreactor 130 at desired time intervals, such as once per hour, once per day, or at another preselected time interval.

The nitrogen feed source 132 can also be delivered to the bioreactor 130 in various ways. In some embodiments, the nitrogen feed source 132 is dosed into the bioreactor 130 via a dosing mechanism. Other methods of delivering the nitrogen feed source 132 to the bioreactor 130 are also contemplated. In yet another embodiment, the nitrogen feed source is dosed into the water management unit 100, and then carried from the water management unit to the bioreactor 130.

In some embodiments, the bioreactor 130 further comprises a substrate upon which bacteria, fungi, and/or other microorganisms can reside within the bioreactor 130. The substrates can be porous and/or comprise a relatively large surface area upon which the bacteria, fungi, and/or other microorganisms can reside. Illustrative substrates that can be used include, but are not limited to, pumice stones, lava stones, ceramic stones, and/or plastic elements. In other embodiments, no substrate is used. Various types of bacteria, fungi, and/or other microorganisms used in ammonification and/or nitrification processes can also be included in the bioreactor 130. According to yet another embodiment, the substrate upon which bacteria, fungi and/or other microorganisms can reside can be provided in the plant growth region 340, such as to facilitate conversion of nitrogen in the plant growth region into nitrates available for plant uptake via one or more of an ammonification and/or a nitrification process.

An aeration system 134 can also be coupled to the bioreactor 130. The aeration system 134 can be configured to deliver one or more gases (e.g., gaseous bubbles) into the bioreactor 130 as desired. In some embodiments, the aeration system 134 is configured to deliver air (e.g., air bubbles) into the bioreactor 130 to aid in the ammonification and/or nitrification processes. The delivered air can include a mixture of oxygen, nitrogen, and carbon dioxide, which can be beneficial and useful for the system 100. For instance, air and/or other gases introduced into the bioreactor 130 via the aeration system 134 can promote the change of nitrite (NO2) into nitrate (NO3) within the ammonification and/or nitrification process. In some embodiments, the aeration system 134 is configured to provide a source of nanobubbles to the system. In some embodiments, nanobubbles are 70-120 nanometers in size, 2500 times smaller than a single grain of salt. They can be formed using various different types of gases. Due to their size, nanobubbles exhibit unique properties that improve numerous physical, chemical, and biological processes. The aeration system 134 can be configured to dissolve gases in the water by compressing the gas flows in the water and then releasing this mixture through nanosized nozzles to create nanobubbles. The nanobubbles can be formed and delivered into the system through any other means, such as ultrasonic waves.

In some embodiments, the aeration system 134 is configured to introduce gas from above the substrate. In other embodiments, the aeration system 134 is configured to introduce gas from below the substrate. The aeration system 134 can also be configured to continuously introduce gas into the bioreactor 130, or it can be configured to introduce gas intermittently or at desired time intervals.

Gases introduced into the bioreactor 130 via the aeration system 134 can also provide additional advantages to the system 100. For instance, without limitation, the gases introduced by the aeration system 134 can aid in mixing and/or moving the water within the bioreactor 130. Additionally, the gases introduced by the aeration system 134 can aid in discharging or removing other gases (e.g., waste gases) from the system 100. For instance, waste gases can be produced during the ammonification and/or nitrification processes. Gases and/or gas bubbles introduced by the aeration system 134 can aid in removing any such waste gases from the system 100. The amount of gas added into the bioreactor 130 via the aeration system 134 can also vary as desired. In some embodiments, the amount of gas added into the bioreactor 130 is between about 1 m³/hour and about 100 m³/hour. More or less gas can also be added depending on the size of the bioreactor 130 and/or the volume of water in the system 100.

As water is circulating between the bioreactor 130 and the water management unit 110, it will be appreciated that bacteria, fungi, and/or other microorganisms can be found throughout the system 100, including in the water management unit 110. In other words, the bacteria, fungi, and/or other microorganisms are not limited to the bioreactor 130 but can be dispersed throughout the system 100 via the pumps, pipes, and/or waterways 102, 104 and the water management unit 110. Filters and/or membranes need not be used or applied to limit the movement of bacteria, fungi, and/or other microorganisms, and in some embodiments, the system 100 is devoid of any such filters and/or membranes. Rather, freely allowing movement of bacteria, fungi, and/or other microorganisms can be advantageous to the system 100. For instance, bacteria, fungi, and/or other microorganisms located throughout the system 100 can aid in breaking down and/or decomposing various organic molecules or products found therein.

In some embodiments, the volume or amount of water flowing through the bioreactor 130 can be controlled and/or managed as desired. For example, in certain embodiments, water flowing through the bioreactor 130 is relatively low, such as about 1 liter/hour. In other embodiments, the water flowing through the bioreactor 130 is higher, such as up to 100 m³/hour. As discussed below, one or more parameters of the water can be controlled via the flow rate through the bioreactor 130.

Various parameters of the water flowing through the system 100 can be measured and adjusted as desired. For instance, in some embodiments, one or more parameters are measured in the bioreactor 130 and/or in the water management unit 110. In further embodiments, one or more parameters are measured as the water flows to and/or from the bioreactor 130 and/or to and/or from the water management unit 110. Measuring such parameters can aid in tracking and/or monitoring the processes taking place within the bioreactor 130 and in the system 100 as a whole. Illustrative parameters that can be measured include, but are not limited to, the pH, the water temperature, the oxygen level of the water, and the nitrate and/or nutrient level (e.g., the number of nitrates and other nutrients). Depending on the measurements taken, flow through the bioreactor 130 can be modified (e.g., increased and/or decreased), the water can be treated, and/or additives can be added to the system 100. In some embodiments, increasing or decreasing the flow of water through the bioreactor 130 can affect the parameters of the water in the system 100.

In certain embodiments, the various parameters can be adjusted and/or modified in response to the measurements taken. These parameters can be adjusted at a number of points along the water flow path, such as in the bioreactor 130 and/or in the water management unit 110.

In one embodiment, the pH of the water is monitored and/or adjusted as desired. For example, the system 100 can include a pH adjustment system 112. The pH adjustment system 112 can be configured to control the pH by adding acids and/or bases to the water as needed. Exemplary acids that can be used include, but are not limited to, nitric acid, sulfuric acid, citric acid, and acetic acid. The acids can be organic acids or artificial acids. Other acids can also be used. In certain embodiments, the pH of the system 100 is modified and/or otherwise controlled to be at between about 5.0 and about 8, between about 5.5 and about 7.5, or between about 6.0 and about 7.

In another embodiment, the temperature of the water is monitored and/or adjusted as desired. For example, the system 100 can include a cooling system 114 for cooling the water. In some of such embodiments, the cooling system 114 comprises a chiller. The system can also include a heating system 116 for heating the water. In some of such embodiments, the heating system 116 comprises a boiler. In certain embodiments, the temperature of the system 100 is modified and/or otherwise controlled to be maintained at between about 15° C. and about 25° C., between about 18° C. and about 23° C., between about 19° C. and about 21° C.

In some embodiments, the oxygen level of the water is monitored and/or adjusted as desired. For example, the system 100 can include an oxygen system 118 that can be configured to add oxygen to the water. In some embodiments, the oxygen system 118 includes a venturi device for adding oxygen to the water. In other embodiments, the oxygen system 118 includes an aerator that is configured to add bubbles (e.g., micro bubbles and/or nano bubbles) into the water. In a particular embodiment, the oxygen system 118 adds nano bubbles into the water. In certain embodiments, the oxygen level of the water in the system 100 is modified and/or otherwise controlled to be at between about mg/L and about 40 mg/L, between about 10 mg/L and about 30 mg/L, or between about mg/L and about 25 mg/L.

In some embodiments, other gas levels can also be monitored and/or adjusted as desired. For example, the system 100 can include a gas system 120 that can be configured to add one or more gases into the water. In some embodiments, the gas system 120 can be configured to add carbon dioxide into the water. Without limitation, carbon dioxide gas can be used to control pH and impart other properties to the water. The gas system 120 can also be configured to add nitrogen gas into the water as desired. Other types of gases can also be added as desired.

In some embodiments, the nutrient levels of the water are monitored and/or adjusted as desired. For instance, the system 100 can include a fertilizer system 122 that can be configured to add fertilizer and/or other minerals to the water. For instance, the fertilizer system 122 can be configured to add various types and/or amounts of trace elements (e.g., iron, manganese, zinc, copper, boron, molybdenum, etc.) into the water. The fertilizer system 122 can also be configured to add fertilizers, hydrolyzed fertilizers, biostimulants, phosphates, calcium, and/or other components that may be advantageous for plant growth.

In particular embodiments, a plasma activated water system 124 is coupled to the water management unit 110. The plasma activated water system 124 can be configured to produce and/or add plasma activated water into the system 100. In some embodiments, plasma activated water can be derived from water, air, and electricity. Plasma activated water can be advantageous in many ways. For instance, without limitation, plasma activated water can include nitrates in the form of nitric acid that can be available for uptake by the plants. Plasma activated water can also be helpful in maintaining a desired pH within the system 100. For instance, the plasma activated water can be helpful in maintaining the pH of the system 100 at between about 5.0 and about 8, between about 5.5 and about 7.5, or between about 6.0 and about 7. Plasma activated water can also be helpful in avoiding the formation of certain precipitates within the system 100.

In some embodiments, the total level of organic derived nitrates available for uptake by the plants is monitored and/or controlled such that the total level of nitrate is between about 2 mmol/L and about 30 mmol/L, between about 6 mmol/L and about 20 mmol/L, or between about 8 mmol/L and about 15 mmol/L. In certain of such embodiments, the total level of organic derived nitrate includes the nitrates produced by the nitrification process and the nitrates dosed into the system (e.g., via dosing the plasma activated water). In such embodiments, the level of organic derived nitrates can be adjusted by increasing/decreasing the flow of the nitrogen feed source 132 into the bioreactor 130 and/or increasing/decreasing the amount of plasma activated water being added to the system 100.

Other parameters can also be monitored and/or adjusted as desired, including, but not limited to, the level of organic pesticides and/or organic fungicides, ozone, and water hardness, etc. The number of ions (e.g., phosphates, calcium, and nitrates) can also be monitored and/or adjusted as desired.

Optionally, in some embodiments, one or more fish and/or other aquatic animals are included in system 100, such as in the water management unit 110. The one or more fish and/or other aquatic animals can aid in the production of nitrates available for uptake by the plants. In other embodiments, fish and/or other aquatic animals are not used.

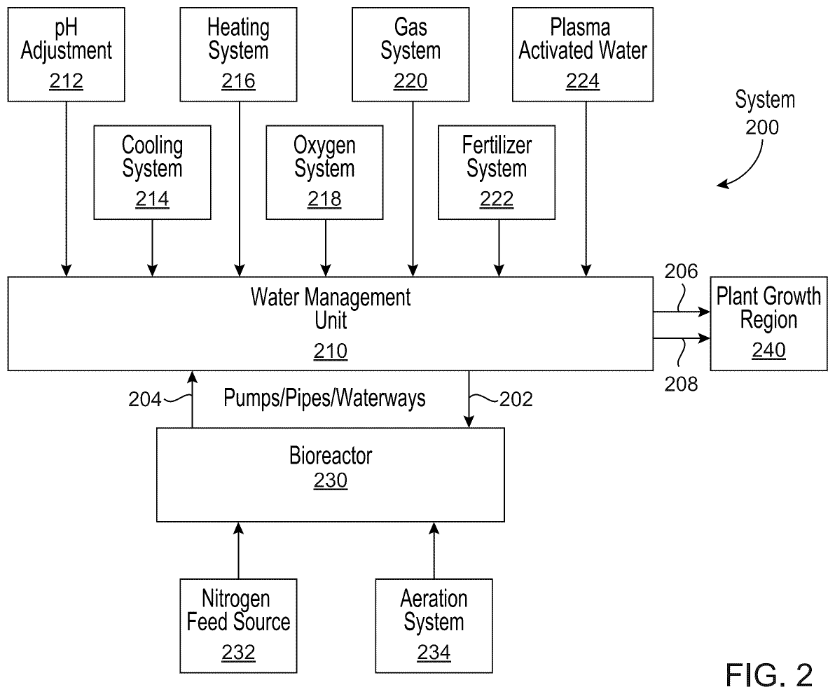

At the user's discretion, treated water from the system 100 can be delivered to a plant growth region 140. For instance, treated water from the system 100 can be delivered to plant growth region 140 via one or more pumps, pipes, and/or waterways 106. Various types of hydroponic plant growth regions 140 are contemplated. In some embodiments, the treated water is delivered and sprayed onto one or more plants in the plant growth region 140. For instance, the treated water can be sprayed from below the plants and/or onto the roots of the plants, which can be referred to as an aeroponic hydroponic system. The treated water can also be sprayed from above the plants and onto the one or more leaves of the plants. The treated water can also be delivered to components used in plant growth regions 140 commonly used in deep water hydroponic systems, N.F.T. hydroponic systems, rolling bench or rolling container/gutter hydroponic systems, tabletop hydroponic systems, and other types of hydroponic systems. As set forth in FIG. 2 and detailed below, in some of such embodiments, the treated water can be recirculated through the system 100. In other embodiments, the treated water is configured for a single use.

In yet further embodiments, the treated water can be delivered to seeds that are germinating in a plant growth region 140. The treated water can also be delivered to substrates that are to be used in plant cultivation. For instance, the treated water can be applied to peat or another soil substrate (e.g., coco, coir, stone wool perlite, ager, paper sludge, etc.) prior to or after a seed or young plant is disposed therein. Thus, it will be appreciated that the treated water can be used in various ways.

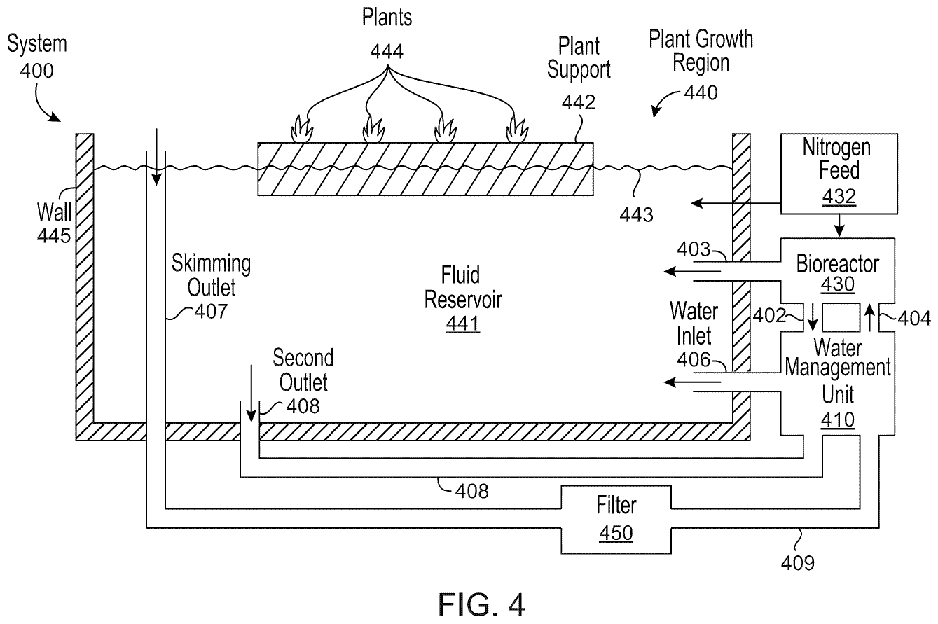

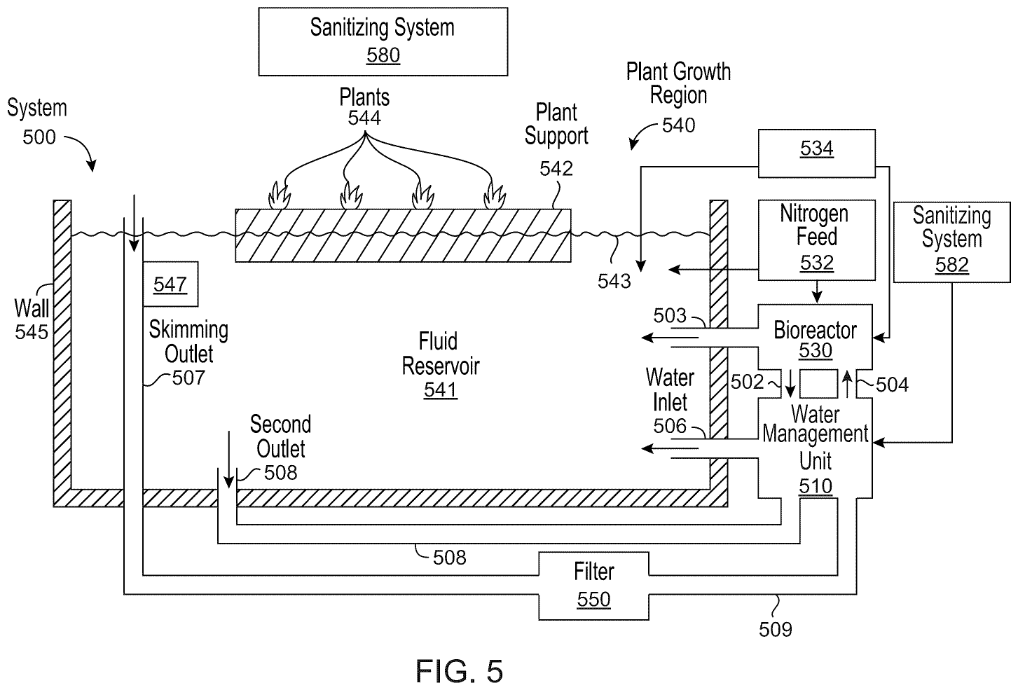

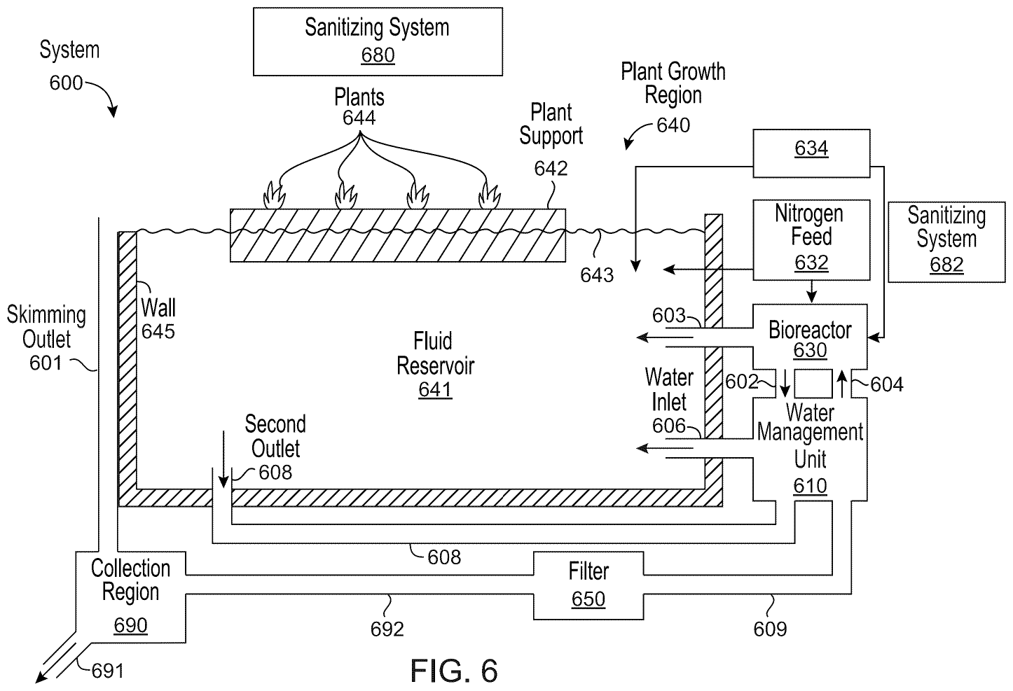

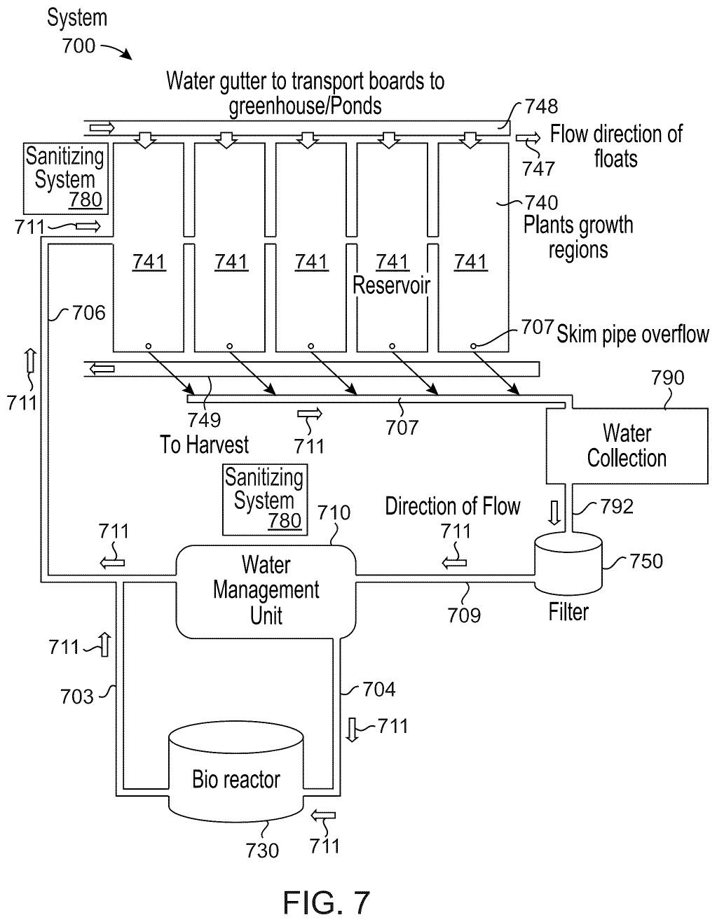

FIG. 2 depicts a schematic illustration for another system 200 that resembles the system 100 described above in certain respects. Accordingly, like features are designated with like reference numerals, with the leading digit incremented to “2.” In addition, FIG. 3 depicts a schematic illustration for another system 300 that resembles the system 100 described above in certain respects. Accordingly, like features are designated with like reference numerals, with the leading digit incremented to “3.” Furthermore, FIG. 4 depicts a cross-sectional diagram for another system 400 that resembles the system 100 described above in certain respects. Accordingly, like features are designated with like reference numerals, with the leading digit incremented to “4.” The same is true for FIG. 5 and FIG. 6. For example, the embodiment depicted in FIG. 2 includes a water management unit 210 that may, in some respects, resemble the water management unit 110 of FIG. 1. Relevant disclosure set forth above regarding similarly identified features thus may not be repeated hereafter. Moreover, specific features of the system 100 and related components shown in FIG. 1 may not be shown or identified by a reference numeral in the drawings or discussed in detail in the written description that follows. However, such features may clearly be the same, or substantially the same, as features depicted in other embodiments and/or described with respect to such embodiments. Accordingly, the relevant descriptions of such features apply equally to the features of system 200, system 300, system 400, system 500, system 600, system 700 and related components depicted in FIG. 2, FIG. 3, FIG. 4, FIG. 5, FIG. 6, and FIG. 7, respectively. Any suitable combination of the features, and variations of the same, described with respect to the system 100 and related components illustrated in FIG. 1 can be employed with anyone of system 200, system 300, system 400, system 500, system 600, system 700 and related components of FIG. 2, FIG. 3, FIG. 4, FIG. 5, FIG. 6, and FIG. 7, respectively, and any combination. This pattern of disclosure applies equally to further embodiments depicted in subsequent figures and described hereafter, wherein the leading digits may be further incremented.

FIG. 2 is a schematic illustration of a system 200 for hydroponic plant cultivation in accordance with another embodiment of the present disclosure. As shown in FIG. 2, the system 200 includes a water management unit 230, a bioreactor 220, and one or more plant growth regions 240. In some embodiments, the system 200 includes a water management unit 210 and a bioreactor 230 in fluid communication with a single plant growth region 240. In other embodiments, the system 200 includes a water management unit 210 and a bioreactor 230 in fluid communication with a plurality of plant growth regions 240. More than one water management units 210 and/or bioreactors 230 can also be used as necessary.

As further illustrated, the water management unit 210, bioreactor 230, and one or more plant growth regions 240 are in fluid communication with each other such that water can be circulated throughout the system 200. For instance, as shown in FIG. 2, water can be circulated through the system 200 via pumps, pipes, and/or waterways represented by the directional arrows 202, 204, 206, 208. In the illustrated embodiment, water is circulated between the water management unit 210 and the one or more plant growth regions 240, and also between the water management unit 210 and the bioreactor 230. However, other flow paths are also contemplated. Additionally, one or more additional components may be added to the system 200 as needed to control and/or modify one or more parameters of the water.

In some embodiments, water is constantly and/or continuously being circulated between the water management unit 210, the bioreactor 230, and the one or more plant growth regions 240. In other embodiments, water is intermittently circulated between the water management unit 210, bioreactor 230, and one or more plant growth regions 240. For instance, flow through the system 200 can be turned on and/or off as desired or at preselected time intervals. The volume of water flowing through the system 200 can also vary. For instance, in some embodiments, approximately the full volume of water within the system 200 is configured to circulate through the bioreactor 230 and water management unit 210 at least once per week. In other embodiments, approximately the full volume of water within the system 200 is configured to circulate through the bioreactor 230 and water management unit 210 at least twice every day, at least once every day, at least once every 2 days, at least once every 3 days, at least once every 4 days, or at another time interval. By circulating water through the bioreactor 230 and the water management unit 210, water treatments or additives can be applied to the water in the system 200 and distributed to the one or more plant growth regions 240. As can be appreciated, the treated water can be delivered to the one or more plant growth regions 240 via one or more pipes and/or jets in such a way as to ensure that the treated water is evenly distributed and/or mixed throughout the one or more plant growth regions 240 so that all plants are reached.

In some embodiments, the one or more plant cultivation regions 240 comprise one or more water reservoirs. In some of such embodiments, the one or more water reservoirs can include floats or rafts upon which the plants are cultivated and/or grown. The floats and/or rafts can be made of various materials that are configured to float on water. Illustrative materials include, but are not limited to, polystyrenes, expanded polystyrenes (e.g., Styrofoam), polypropylenes, expanded polypropylenes, and other types of plastics and/or polymeric materials. The floats and/or rafts can be molded, blow molded, or otherwise formed into various shapes capable of holding plants and floating on water. In some embodiments, the floats and/or rafts can be configured to move about the one or more reservoirs during the cultivation cycle. The one or more reservoirs can also be disposed in one or more green houses as desired. The one or more water reservoirs can also be referred to as water basins or water ponds.

In particular embodiments, the floats and/or rafts are prepared by disposing plant seeds or plants in a small amount of peat or soil substrate (e.g., coco, coir, stone wool perlite, ager, paper sludge, etc.) that is disposed on the floats and/or rafts. As the seeds germinate, the roots extend into the water within the water reservoir where they can obtain nutrients. In certain embodiments, overhead irrigation can be employed during the initial growth stages to ensure adequate nutrients reach the plants. In some of such instances, treated water can be delivered to the plants or seeds via overhead irrigation to aid in the growth process. Without limitation, illustrative plants that can be cultivated in the disclosed systems and methods include, but are not limited to, lettuce, spinach, cabbage, romaine, sprouts, and herbs. Other types of plants are also contemplated. In certain embodiments, the plants cultivated in the disclosed systems and methods include those that have a propensity to release growth inhibiting exudates and/or exudates that are detrimental to plant, and even exudates containing toxins into the reservoir, such as for example, without limitation, spinach, cilantro, and other similar plants.

The one or more reservoirs can be various sizes and/or shapes. In some embodiments, the one or more reservoirs are substantially rectangular in shape. For instance, the one or more reservoirs can be between about 7 meters and about 15 meters wide, and between about 100 meters and about 200 meters long. Larger and/or smaller reservoirs can also be used, such as between about 2 meters and about 5 meters wide, and between about 5 meters and about 12 meters long. Other sizes and/or shapes are also contemplated.

The depth of the one or more reservoirs can also vary. For instance, in some embodiments, the one or more reservoirs are between about 20 cm and about 35 cm deep. In other embodiments, the one or more reservoirs are between about 3 cm and about 5 cm deep. Other depths are also within the scope of the disclosure. In some instances, hydroponic plant cultivation using the one or more reservoirs is referred to as a deep pond growing technique. In some embodiments the deep pond growing technique, or deep-water reservoir technique can be any system in which the water is sufficiently deep to permit immersion of a majority of the root system of a plant in the water.

In other embodiments, the one or more plant growth regions 240 can comprise one or more components used in a tabletop hydroponic cultivation system, a N.F.T. (nutrient film technology) hydroponic system, or a rolling bench or rolling container/gutter hydroponic system. For instance, the one or more plant growth regions 240 can include elongated gutters into which the water can be delivered, utilized by the plants, and recycled through the system 200. It will thus be appreciated that various types of hydroponic cultivation techniques can be used in the plant growth regions 240. The plant growth regions 240 can also be disposed in one or more green houses as desired.

With continued reference to FIG. 2, the system 200 includes a bioreactor 230 that can be configured to control and/or modify one or more parameters of the water flowing through the system 200. As discussed with regards to FIG. 1, the bioreactor 230 is configured to convert a nitrogen feed source 232 into nitrates available for plant uptake via one or more of an ammonification and/or a nitrification process. The nitrogen feed source 232 can be organic and can comprise any variety of proteins, amino acids, ammonium, urea, organic acid, and/or any other organic molecule that can be digested and converted into nitrate via an ammonification and/or nitrification process. In some embodiments, the nitrogen feed source 232 comprises one or more of a plant based nitrogen source, an animal based nitrogen source, or an artificially created nitrogen source. The nitrogen feed source 232 can be delivered into the bioreactor 230 where it is converted into nitrogen compounds that can be delivered to and used by the plants in the one or more plant growth regions 240. In yet another embodiment, the nitrogen feed source 232 can be delivered to the water management unit 210, and then carried from the water management unit to the bioreactor 230.

As was discussed with regards to FIG. 1, in some embodiments, the bioreactor 230 further comprises a substrate upon which bacteria, fungi, and/or other microorganisms can reside within the bioreactor 230. The substrates can be porous and/or comprise a relatively large surface area upon which the bacteria, fungi, and/or other microorganisms can reside. Illustrative substrates that can used include, but are not limited to, pumice stones, lava stones, ceramic stones, and/or plastic elements. In other embodiments, no substrate is used. Various types of bacteria, fungi, and/or other microorganisms used in ammonification and/or nitrification processes can also be included in the bioreactor 230. An aeration system 234 can also be coupled to the bioreactor 230. The aeration system 234 can be configured to deliver one or more gases (e.g., gaseous bubbles) into the bioreactor 230 as desired. In some embodiments, the aeration system 234 is configured to deliver air (e.g., air bubbles) into the bioreactor 230 to aid in the ammonification and/or nitrification processes. The delivered air can include a mixture of oxygen, nitrogen, and carbon dioxide which can be beneficial and useful for the system 200. For instance, air and/or other gases introduced into the bioreactor 230 via the aeration system 234 can promote the change of nitrite (NO2) into nitrate (NO3) within the ammonification and/or nitrification process.

Gases introduced into the bioreactor 230 via the aeration system 234 can also provide additional advantages to the system 200. For instance, without limitation, the gases introduced by the aeration system 234 can aid in mixing and/or moving the water within the bioreactor 230. Additionally, the gases introduced by the aeration system 234 can aid in discharging or removing other gases (e.g., waste gases) from the system 200. For instance, waste gases can be produced during the ammonification and/or nitrification processes. Gases and/or gas bubbles introduced by the aeration system 234 can aid in removing any such waste gases from the system 200.

As water is circulating between the bioreactor 230, the water management unit 210, and the one or more plant growth regions 240, it will be appreciated that bacteria, fungi, and/or other microorganisms can be found throughout the system 200, including in the water management unit 210 and/or the one or more plant growth regions 240. In other words, the bacteria, fungi, and/or other microorganisms are not limited to the bioreactor 210 but can be dispersed throughout the system 200 via the pumps, pipes, and/or waterways 202, 204, 206, 208 and the water management unit 210. Filters and/or membranes need not be used or applied to limit the movement of bacteria, fungi, and/or other microorganisms, and in some embodiments, the system 200 is devoid of any such filters and/or membranes. Rather, freely allowing movement of bacteria, fungi, and/or other microorganisms can be advantageous to the system 200. For instance, bacteria, fungi, and/or other microorganisms located in the one or more water plant growth regions 240 can aid in breaking down and/or decomposing various organic molecules or products found therein. Bacteria, fungi, and/or other microorganisms can also aid in cleaning the water by breaking down and/or decomposing organic molecules or products that originate from the plant substrates, plants (e.g., in root excrements), and/or organic acids that may end up in the one or more plant growth regions 240. In one embodiment, substrates upon which bacteria, fungi and/or other microorganisms can reside can be provided in the plant growth region 340, to facilitate breaking down and/or decomposing various organic molecules or products found therein.

In some embodiments, the volume or amount of water flowing through the bioreactor 230 can be controlled and/or managed as desired. For example, in certain embodiments, water flowing through the bioreactor 230 is relatively low, such as about 1 liter/hour. In other embodiments the water flowing through the bioreactor 230 is higher, such as up to 100 m³/hour. As discussed below, one or more parameters of the water can be controlled via the flow rate through the bioreactor 230.

As was discussed with regards to FIG. 1, various parameters of the water flowing through the system 200 can be measured and adjusted as desired. For instance, in some embodiments, one or more parameters are measured in the one or more plant growth regions 240, in the bioreactor 230, and/or in the water management unit 210. In further embodiments, one or more parameters are measured as the water flows to and/or from the one or more plant growth regions 240, to and/or from the bioreactor 230, and/or to and/or from the water management unit 210. Measuring such parameters can aid in tracking or monitoring the processes taking place within the bioreactor 230 and in the system 200 as a whole. Illustrative parameters that can be measured include, but are not limited to, the pH, the water temperature, the oxygen level of the water, and the nitrate and/or nutrient level (e.g., the number of nitrates and other nutrients). Depending on the measurements taken, flow through the bioreactor 230 can be modified (e.g., increased and/or decreased), the water can be treated, and/or additives can be added to the system 200. In some embodiments, increasing or decreasing the flow of water through the bioreactor 230 can affect the parameters of the water in the system 200.

In certain embodiments, the various parameters can be adjusted and/or modified in response to the measurements taken. These parameters can be adjusted at a number of points along the water flow path, such as in the bioreactor 230 and/or in the water management unit 210. If desired, the parameters can also be adjusted in the one or more plant growth regions 240.

In one embodiment, the pH of the water is monitored and/or adjusted as desired. For example, the system 200 can include a pH adjustment system 212. The pH adjustment system 212 can be configured to control the pH by adding acids and/or bases to the water as needed. Exemplary acids that can be used include, but are not limited to, nitric acid, sulfuric acid, citric acid, and acetic acid. The acids can be organic acids or artificial acids. Other acids can also be used. In certain embodiments, the pH of the system 200 is modified and/or otherwise controlled to be at between about 5.0 and about 8, between about 5.5 and about 7.5, or between about 6.0 and about 7.

In another embodiment, the temperature of the water is monitored and/or adjusted as desired. For example, the system 200 can include a cooling system 214 for cooling the water. In some of such embodiments, the cooling system 214 comprises a chiller. The system can also include a heating system 216 for heating the water. In some of such embodiments, the heating system 216 comprises a boiler. In certain embodiments, the temperature of the system 200 is modified and/or otherwise controlled to be maintained at between about 15° C. and about 25° C., between about 18° C. and about 23° C., or between about 19° C. and about 21° C.

In particular embodiments, the system 200 is further configured to cool environment in the one or more plant growth regions 240 at night to create a cooler nighttime temperature for the plants. In some of such embodiments, the system 200 is configured to cool the water by between about 1° C. and about 5° C., or between about 2° C. and about 4° C. In some of such embodiments, the average 24 hour temperature is brought down by between about 1° C. and about 5° C., or between about 2° C. and about 4° C. by cooling the temperature of the one or more plant growth regions 240 at night.

In some embodiments, the oxygen level of the water is monitored and/or adjusted as desired. For example, the system 200 can include an oxygen system 218 that can be configured to add oxygen to the water. In some embodiments, the oxygen system 218 includes a venturi device for adding oxygen to the water. In other embodiments, the oxygen system 218 includes an aerator that is configured to add bubbles (e.g., micro bubbles and/or nano bubbles) into the water. In a particular embodiment, the oxygen system 218 adds nano bubbles into the water. In certain embodiments, the oxygen level of the water in the system 200 is modified and/or otherwise controlled to be at between about 5 mg/L and about 40 mg/L, between about 10 mg/L and about 30 mg/L, or between about 15 mg/L and about 25 mg/L.

In some embodiments, other gas levels can also be monitored and/or adjusted as desired. For example, the system 200 can include a gas system 220 that can be configured to add one or more gases into the water. In some embodiments, the gas system 220 can be configured to add carbon dioxide into the water. Without limitation, carbon dioxide gas can be used to control pH and impart other properties to the water. The gas system 220 can also be configured to add nitrogen gas into the water as desired. Other types of gases can also be added as desired.

In some embodiments, the nutrient levels of the water are monitored and/or adjusted as desired. For instance, the system 200 can include a fertilizer system 222 that can be configured to add fertilizer and/or other minerals to the water. For instance, the fertilizer system 222 can be configured to add various types and/or amounts of trace elements (e.g., iron, manganese, zinc, copper, boron, molybdenum, etc.) into the water. The fertilizer system 222 can also be configured to add fertilizers, hydrolyzed fertilizers, biostimulants, phosphates, calcium, and/or other components that may be advantageous for plant growth.

In particular embodiments, a plasma activated water system 224 is coupled to the water management unit 210. The plasma activated water system 224 can be configured to produce and/or add plasma activated water into the system 200. In some embodiments, plasma activated water can be derived from water, air, and electricity.

Plasma activated water can be advantageous in many ways. For instance, without limitation, plasma activated water can include nitrates in the form of nitric acid that can be available for uptake by the plants. Plasma activated water can also be helpful in maintaining a desired pH within the system 200. For instance, the plasma activated water can be helpful in maintaining the pH of the system 200 at between about 5.0 and about 8, between about 5.5 and about 7.5, or between about 6.0 and about 7. Plasma activated water can also be helpful in avoiding the formation of certain precipitates within the system 200.

In some embodiments, the total level of organic derived nitrates available for uptake by the plants is monitored and/or controlled such that the total level of nitrate is between about 2 mmol/L and about 30 mmol/L, between about 6 mmol/L and about 20 mmol/L, or between about 8 mmol/L and about 15 mmol/L. In certain of such embodiments, the total level of organic derived nitrate includes the nitrates produced by the nitrification process and the nitrates dosed into the system (e.g., via dosing the plasma activated water). In such embodiments, the level of organic derived nitrates can be adjusted by increasing/decreasing the flow of the nitrogen feed source 232 into the bioreactor 230 and/or increasing/decreasing the amount of plasma activated water being added to the system 200.

Other parameters can also be monitored and/or adjusted as desired, including, but not limited to, the level of organic pesticides and/or organic fungicides, ozone, and water hardness, etc. The number of ions (e.g., phosphates, calcium, and nitrates) can also be monitored and/or adjusted as desired. Optionally, in some embodiments, one or more fish and/or other aquatic animals are included in system 200, such as in the water management unit 210. The one or more fish and/or other aquatic animals can aid in the production of nitrates available for uptake by the plants. In other embodiments, fish and/or other aquatic animals are not used.

FIG. 3 is a schematic illustration of a system 300 for another embodiment of a hydroponic plant cultivation in accordance with the present disclosure. As shown in the embodiment of FIG. 3, the system 300 includes a water management unit 330, a bioreactor 320, and one or more plant growth regions 340. In some embodiments, the system 300 includes a water management unit 310 and a bioreactor 330 in fluid communication with a single plant growth region 340. In other embodiments, the system 300 includes a water management unit 310 and a bioreactor 330 in fluid communication with a plurality of plant growth regions 340. More than one water management units 310 and/or bioreactors 330 can also be used as necessary.

As further illustrated, in certain embodiments, the water management unit 310, bioreactor 330, and one or more plant growth regions 340 are in fluid communication with each other such that water can be circulated throughout the system 300. For instance, as shown in FIG. 3, water can be circulated through the system 300 via pumps, pipes, and/or waterways represented by the directional arrows 302, 304, 306, 308. In the illustrated embodiment, water is circulated between the water management unit 310 and the one or more plant growth regions 340, and also between the water management unit 310 and the bioreactor 330. However, other flow paths are also contemplated. Additionally, one or more additional components may be added to the system 300 as needed to control and/or modify one or more parameters of the water.

In some embodiments, the bioreactor 330 is in fluid communication with the water management unit 310 and the plant growth region 340 such that the bioreactor is directly coupled to both. In some embodiments, the bioreactor is in fluid communication directly with the plant growth region 340 through fluid conduit 303. In some embodiments, the flow of water is depicted in FIG. 3 through the use of directional arrows for fluid conduits 302, 303, 304, 306, and 308. As will be discussed below, according to certain embodiments the system 300 also has a skimming system 370 that is in fluid communication with the plant growth region and the water management unit through fluid conduits 307 and 309 respectively.

In some embodiments, water is constantly and/or continuously being circulated between the water management unit 310, the bioreactor 330, and the one or more plant growth regions 340. In other embodiments, water is intermittently circulated between the water management unit 310, bioreactor 330, and one or more plant growth regions 340. For instance, flow through the system 300 can be turned on and/or off as desired or at preselected time intervals. The volume of water flowing through the system 300 can also vary. For instance, in some embodiments, approximately the full volume of water within the system 300 is configured to circulate through the bioreactor 330 and water management unit 310 at least once per week. In other embodiments, approximately the full volume of water within the system 300 is configured to circulate through the bioreactor 330 and water management unit 310 at least twice every day, at least once every day, at least once every 2 days, at least once every 3 days, at least once every 4 days, or at another time interval. By circulating water through the bioreactor 330 and the water management unit 310, water treatments or additives can be applied to the water in the system 300 and distributed to the one or more plant growth regions 340. As can be appreciated, the treated water can be delivered to the one or more plant growth regions 340 via one or more pipes and/or jets in such a way as to ensure that the treated water is evenly distributed and/or mixed throughout the one or more plant growth regions 340 so that all plants are reached.

The flow of water through the system may be controlled in some embodiments with a water management computer 360. In some embodiments this is a specialized computer to control pumps, valves, or other means of controlling flow in the system. In some embodiments the water management computer controls a flow rate controller that is configured to adjust a volume percent of water cycled, or recirculated, through the system. The recirculated water stays within the closed system. In some embodiments, the flow rate controller is configured to recirculate at least 80%, at least 90%, at least 95% and/or even 100% of the volume of water present in the system every 4 hours to every 10 days. In some embodiments, the flow rate controller adjusts pumps, valves, and other means of controlling flow of water in the system and replaces or exchanges the water with water from outside the system, in an open system.

In some embodiments, the one or more plant cultivation regions 340 comprise one or more water reservoirs 341. In some of such embodiments, the one or more water reservoirs can include floats or rafts upon which the plants are cultivated and/or grown. This will be discussed in more detail below with reference to FIGS. 4 to 6. The floats and/or rafts can be made of various materials that are configured to float on water. Illustrative materials include, but are not limited to, polystyrenes, expanded polystyrenes (e.g., Styrofoam), polypropylenes, expanded polypropylenes, and other types of plastics and/or polymeric materials. The floats and/or rafts can be molded, blow molded, or otherwise formed into various shapes capable of holding plants and floating on water. In some embodiments, the floats and/or rafts can be configured to move about the one or more reservoirs during the cultivation cycle. The one or more reservoirs can also be disposed in one or more green houses as desired. The one or more water reservoirs can also be referred to as water basins or water ponds.

In particular embodiments, the floats and/or rafts are prepared by disposing plant seeds or plants in a small amount of peat or soil substrate (e.g., coco, coir, stone wool perlite, ager, paper sludge, etc.) that is disposed on the floats and/or rafts. As the seeds germinate, the roots extend into the water within the water reservoir where they can obtain nutrients. In certain embodiments, overhead irrigation can be employed during the initial growth stages to ensure adequate nutrients reach the plants. In some of such instances, treated water can be delivered to the plants or seeds via overhead irrigation to aid in the growth process. Without limitation, illustrative plants that can be cultivated in the disclosed systems and methods include, but are not limited to, lettuce, spinach, cabbage, romaine, sprouts, and herbs. Other types of plants are also contemplated. In certain embodiments, the plants cultivated in the disclosed systems and methods include those that have a propensity release growth inhibiting exudates and/or exudates that are detrimental to plant, and even exudates containing toxins, such as for example, without limitation, spinach, cilantro, and other similar plants.

The one or more reservoirs can be various sizes and/or shapes. In some embodiments, the one or more reservoirs are substantially rectangular in shape. For instance, the one or more reservoirs can be between about 7 meters and about 15 meters wide, and between about 100 meters and about 300 meters long. Larger and/or smaller reservoirs can also be used, such as between about 2 meters and about 5 meters wide, and between about 5 meters and about 12 meters long. Other sizes and/or shapes are also contemplated.

The depth of the one or more reservoirs can also vary. For instance, in some embodiments the one or more reservoirs are deep-water reservoirs and are between 3 cm and 50 cm in depth. In some embodiments, the one or more reservoirs are between about 5 cm and about 45 cm deep. In some embodiments, the one or more reservoirs are between about 20 cm and about 35 cm deep. In some embodiments, the one or more reservoirs are between about 25 cm and about 30 cm deep. In other embodiments, the one or more reservoirs are between about 3 cm and about 5 cm deep. Other depths are also within the scope of the disclosure. In some instances, hydroponic plant cultivation using the one or more reservoirs is referred to as a deep pond growing technique. In some embodiments, the reservoir is at least 10 cm deep. In some embodiments, the reservoir is at least 15 cm deep. In some embodiments, the reservoir is no more than 100 cm deep. In some embodiments, the reservoir is no more than 75 cm deep. In some embodiments, the reservoir is no more than 60 cm deep.

In other embodiments, the one or more plant growth regions 340 can comprise one or more components used in a tabletop hydroponic cultivation system, a N.F.T. (nutrient film technology) hydroponic system, or a rolling bench or rolling container/gutter hydroponic system. For instance, the one or more plant growth regions 340 can include elongated gutters into which the water can be delivered, utilized by the plants, and recycled through the system 300. It will thus be appreciated that various types of hydroponic cultivation techniques can be used in the plant growth regions 340. The plant growth regions 340 can also be disposed in one or more green houses as desired.

With continued reference to FIG. 3, in one embodiment, the system 300 includes a bioreactor 330 that can be configured to control and/or modify one or more parameters of the water flowing through the system 300. As was discussed with regards to FIG. 1, the bioreactor 330 may be configured to convert a nitrogen feed source 332 into nitrates available for plant uptake via one or more of an ammonification and/or a nitrification process. The nitrogen feed source 332 can be organic and can comprise any variety of proteins, amino acids, ammonium, urea, organic acid, and/or any other organic molecule that can be digested and converted into nitrate via an ammonification and/or nitrification process. In some embodiments, the nitrogen feed source 332 comprises one or more of a plant based nitrogen source, an animal based nitrogen source, or an artificially created nitrogen source. The nitrogen feed source 332 can be delivered into the bioreactor 330 where it is converted into nitrogen compounds that can be delivered to and used by the plants in the one or more plant growth regions 340. In some embodiments, the nitrogen feed source 332 can be delivered into the plant growth region 340 to provide nitrogen compounds to any microorganisms for ammonification and/or nitrification that reside in plant growth region 340.

As was discussed with regards to FIG. 1, in some embodiments, the bioreactor 330 further comprises a substrate upon which bacteria, fungi, and/or other microorganisms can reside within the bioreactor 330. The substrates can be porous and/or comprise a relatively large surface area upon which the bacteria, fungi, and/or other microorganisms can reside. Illustrative substrates that can used include, but are not limited to, pumice stones, lava stones, ceramic stones, and/or plastic elements. In other embodiments, no substrate is used. Various types of bacteria, fungi, and/or other microorganisms used in ammonification and/or nitrification processes can also be included in the bioreactor 330. An aeration system 334 can also be coupled to the bioreactor 330. The aeration system 334 can be configured to deliver one or more gases (e.g., gaseous bubbles) into the bioreactor 330 as desired. In some embodiments, the aeration system 334 is configured to deliver air (e.g., air bubbles) into the bioreactor 330 to aid in the ammonification and/or nitrification processes. The delivered air can include a mixture of oxygen, nitrogen, and carbon dioxide which can be beneficial and useful for the system 300. For instance, air and/or other gases introduced into the bioreactor 330 via the aeration system 334 can promote the change of nitrite (NO2) into nitrate (NO3) within the ammonification and/or nitrification process. As is depicted in FIG. 3, the aeration system 334 can also be coupled directly to the plant growth region 340.

Gases introduced into the bioreactor 330 via the aeration system 334 can also provide additional advantages to the system 300. For instance, without limitation, the gases introduced by the aeration system 334 can aid in mixing and/or moving the water within the bioreactor 330. Additionally, the gases introduced by the aeration system 334 can aid in discharging or removing other gases (e.g., waste gases) from the system 300. For instance, waste gases can be produced during the ammonification and/or nitrification processes. Gases and/or gas bubbles introduced by the aeration system 334 can aid in removing any such waste gases from the system 300.

As water is circulating between the bioreactor 330, the water management unit 310, and the one or more plant growth regions 340, it will be appreciated that bacteria, fungi, and/or other microorganisms can be found throughout the system 300, including in the water management unit 310 and/or the one or more plant growth regions 340. In other words, the bacteria, fungi, and/or other microorganisms are not limited to the bioreactor 310 but can be dispersed throughout the system 300 via the pumps, pipes, and/or waterways 302, 304, 306, 308 and the water management unit 310. Filters and/or membranes need not be used or applied to limit the movement of bacteria, fungi, and/or other microorganisms, and in some embodiments, the system 300 is devoid of any such filters and/or membranes. Rather, freely allowing movement of bacteria, fungi, and/or other microorganisms can be advantageous to the system 300. For instance, bacteria, fungi, and/or other microorganisms located in the one or more plant growth regions 340 can aid in breaking down and/or decomposing various organic molecules or products found therein. Bacteria, fungi, and/or other microorganisms can also aid in cleaning the water by breaking down and/or decomposing organic molecules or products that originate from the plant substrates, plants (e.g., in root excrements), and/or organic acids that may end up in the one or more plant growth regions 340. According to yet another embodiment, the substrate upon which bacteria, fungi and/or other microorganisms can reside can be provided in the plant growth region 340, such as to facilitate conversion of nitrogen in the plant growth region into nitrates available for plant uptake via one or more of an ammonification and/or a nitrification process.

In addition, as is depicted in the schematic of FIG. 3, in one embodiment the system 300 includes a skimming system 370. In some embodiments, the skimming system is in fluid communication with both the plant growth region 340 through fluid conduit 307 and with the water management unit 310 through fluid conduit 309. According to certain embodiments, the skimming system 370 includes the fluid conduit 307, which is fluidly connected to a skimming outlet 407 to skim water from plant growth region 340. The plant growth region 340 can also have a second water outlet 308, in certain embodiments, which fluidly couples the plant growth region 340 directly to the water management unit 310. According to certain embodiments, the skimming system 370, which will be discussed in greater detail below, can comprise any structure configured to remove the top layer of water, and/or any floating material or contaminant on the surface of the water.

As the plants grow in the plant growth region 340 they can often accumulate an exudate, which can include contaminants, fatty acid residues, or other substances, which then can stifle the roots of the plants growing in the plant growth region 340. The skimming system 370, according to certain embodiments, is configured to remove this exudate and any possible contaminants while also maintaining water efficiency by only removing the top layers of water where these typically hydrophobic exudates collect. According to certain embodiments, the top layer of water can include any floating material on top of the surface of the water, and a volume of water at and adjacent to the surface, and may be measured in depth or volume percent of fluid in the fluid reservoir in the plant growth region 340. Non-limiting examples of the depth of the top layer of water in the fluid reservoir can be under 1 cm, 2 cm, 3 cm, 4 cm, 5 cm, 6 cm, 7 cm, 8 cm, 9 cm, 10 cm, 11 cm, 12 cm, 13 cm, 14 cm, cm, 16 cm, 17 cm, 18 cm, 19 cm, or 20 cm.

In some embodiments, the volume or amount of water flowing through the bioreactor 330 can be controlled and/or managed as desired. For example, in certain embodiments, water flowing through the bioreactor 330 is relatively low, such as about 1 liter/hour. In other embodiments, the water flowing through the bioreactor 330 is higher, such as up to 100 m³/hour. As discussed below, one or more parameters of the water can be controlled via the flow rate through the bioreactor 330.

As was discussed with regards to FIG. 1, various parameters of the water flowing through the system 300 can be measured and adjusted as desired. For instance, in some embodiments, one or more parameters are measured in the one or more plant growth regions 340, in the bioreactor 330, and/or in the water management unit 310. In further embodiments, one or more parameters are measured as the water flows to and/or from the one or more plant growth regions 340, to and/or from the bioreactor 330, and/or to and/or from the water management unit 310. Measuring such parameters can aid in tracking or monitoring the processes taking place within the bioreactor 330 and in the system 300 as a whole. Illustrative parameters that can be measured include, but are not limited to, the pH, the water temperature, the oxygen level of the water, and the nitrate and/or nutrient level (e.g., the number of nitrates and other nutrients). Depending on the measurements taken, flow through the bioreactor 330 can be modified (e.g., increased and/or decreased), the water can be treated, and/or additives can be added to the system 300. In some embodiments, increasing or decreasing the flow of water through the bioreactor 330 can affect the parameters of the water in the system 300.

In some embodiments, both parameters in the water in system 300 and the flow of water through the system can be controlled through a water management computer 360. As is depicted in FIG. 3, in some embodiments the flow of water through the system is controlled with a water management computer 360 that is operable linked to the water management unit 310. The water management computer 360 can be configured to control pumps, valves, and other means of controlling the flow of water through the system. In some embodiments, the water management computer 360 controls the flow of water through the fluid conduits 302, 304, 306, 307, and 309. In some embodiments, the water management computer 360 will control the flow of water through the skimming system 308.

In certain embodiments, the various parameters can be adjusted and/or modified in response to the measurements taken. According to certain embodiments, these parameters can be adjusted at a number of points along the water flow path, such as in the bioreactor 330 and/or in the water management unit 310. If desired, the parameters can also be adjusted in the one or more plant growth regions 340.

In some embodiments, any one of the following parameters or parameters elsewhere described herein can be measured and controlled with the water management computer 360. The water management computer 360 can either automate the adjustment of the parameter or it can alert a user based on a predetermined change to the parameter so the user can make the necessary adjustments. In certain embodiments, the water management computer can either be a specialized computer configured to measure parameters in the system 300 or a generalized computer capable of connecting to the water management unit 340 either through a direct connection or via WiFi. The generalized computer may be a handheld device.

In one embodiment, the pH of the water is monitored and/or adjusted as desired. For example, the system 300 can include a pH adjustment system 312. The pH adjustment system 312 can be configured to control the pH by adding acids and/or bases to the water as needed. Exemplary acids that can be used include, but are not limited to, nitric acid, sulfuric acid, citric acid, and acetic acid. The acids can be organic acids or artificial acids. Other acids can also be used. In certain embodiments, the pH of the system 300 is modified and/or otherwise controlled to be at between about 5.0 and about 8, between about 5.5 and about 7.5, or between about 6.0 and about 7.

In another embodiment, the temperature of the water is monitored and/or adjusted as desired. For example, the system 300 can include a cooling system 314 for cooling the water. In some of such embodiments, the cooling system 314 comprises a chiller. The system can also include a heating system 316 for heating the water. In some of such embodiments, the heating system 316 comprises a boiler. In certain embodiments, the temperature of the system 300 is modified and/or otherwise controlled to be maintained at between about 15° C. and about 25° C., between about 18° C. and about 23° C., or between about 19° C. and about 21° C.

In particular embodiments, the system 300 is further configured to cool environment in the one or more plant growth regions 340 at night to create a cooler nighttime temperature for the plants. In some of such embodiments, the system 300 is configured to cool the water by between about 1° C. and about 5° C., or between about 2° C. and about 4° C. In some of such embodiments, the average 24 hour temperature is brought down by between about 1° C. and about 5° C., or between about 2° C. and about 4° C. by cooling the temperature of the one or more plant growth regions 340 at night.

In some embodiments, the oxygen level of the water is monitored and/or adjusted as desired. For example, the system 300 can include an oxygen system 318 that can be configured to add oxygen to the water. In some embodiments, the oxygen system 318 includes a venturi device for adding oxygen to the water. In other embodiments, the oxygen system 318 includes an aerator that is configured to add bubbles (e.g., micro bubbles and/or nano bubbles) into the water. In a particular embodiment, the oxygen system 318 adds nano bubbles into the water. In certain embodiments, the oxygen level of the water in the system 300 is modified and/or otherwise controlled to be at between about 5 mg/L and about 40 mg/L, between about 10 mg/L and about 30 mg/L, or between about 15 mg/L and about 25 mg/L.

In some embodiments, other gas levels can also be monitored and/or adjusted as desired. For example, the system 300 can include a gas system 320 that can be configured to add one or more gases into the water. In some embodiments, the gas system 320 can be configured to add carbon dioxide into the water. Without limitation, carbon dioxide gas can be used to control pH and impart other properties to the water. The gas system 320 can also be configured to add nitrogen gas into the water as desired. Other types of gases can also be added as desired.

In some embodiments, the nutrient levels of the water are monitored and/or adjusted as desired. For instance, the system 300 can include a fertilizer system 322 that can be configured to add fertilizer and/or other minerals to the water. For instance, the fertilizer system 322 can be configured to add various types and/or amounts of trace elements (e.g., iron, manganese, zinc, copper, boron, molybdenum, etc.) into the water. The fertilizer system 322 can also be configured to add fertilizers, hydrolyzed fertilizers, biostimulants, phosphates, calcium, and/or other components that may be advantageous for plant growth.

In particular embodiments, a plasma activated water system 324 is coupled to the water management unit 310. The plasma activated water system 324 can be configured to produce and/or add plasma activated water into the system 300. In some embodiments, plasma activated water can be derived from water, air, and electricity.

Plasma activated water can be advantageous in many ways. For instance, without limitation, plasma activated water can include nitrates in the form of nitric acid that can be available for uptake by the plants. Plasma activated water can also be helpful in maintaining a desired pH within the system 300. For instance, the plasma activated water can be helpful in maintaining the pH of the system 300 at between about 5.0 and about 8, between about 5.5 and about 7.5, or between about 6.0 and about 7. Plasma activated water can also be helpful in avoiding the formation of certain precipitates within the system 300.

In some embodiments, the total level of organic derived nitrates available for uptake by the plants is monitored and/or controlled such that the total level of nitrate is between about 2 mmol/L and about 30 mmol/L, between about 6 mmol/L and about 20 mmol/L, or between about 8 mmol/L and about 15 mmol/L. In certain of such embodiments, the total level of organic derived nitrate includes the nitrates produced by the nitrification process and the nitrates dosed into the system (e.g., via dosing the plasma activated water). In such embodiments, the level of organic derived nitrates can be adjusted by increasing/decreasing the flow of the nitrogen feed source 332 into the bioreactor 330 and/or increasing/decreasing the amount of plasma activated water being added to the system 300.

Other parameters can also be monitored and/or adjusted as desired, including, but not limited to, the level of organic pesticides and/or organic fungicides, ozone, and water hardness, etc. The number of ions (e.g., phosphates, calcium, and nitrates) can also be monitored and/or adjusted as desired. Optionally, in some embodiments, one or more fish and/or other aquatic animals are included in system 300, such as in the water management unit 310. The one or more fish and/or other aquatic animals can aid in the production of nitrates available for uptake by the plants. In other embodiments, fish and/or other aquatic animals are not used.

With reference to FIG. 4, a cross-sectional perspective of system 400 for yet another embodiment of a hydroponic plant cultivation system is shown. As was described above, like features are designated with like reference numerals, with the leading digit incremented to “4.” Specific features of the system 100 and related components shown in FIG. 1 may not be shown or identified by a reference numeral in the drawings or discussed in detail in the written description that follows. However, such features may clearly be the same, or substantially the same, as features depicted in other embodiments and/or described with respect to such embodiments. Accordingly, the relevant descriptions of such features apply equally to the features of system 200, system 300, system 400, system 500, system 600 and related components depicted in FIG. 2, FIG. 3, FIG. 4, FIG. 5, and FIG. 6, respectively. Any suitable combination of the features, and variations of the same, described with respect to the system 100 and related components illustrated in FIG. 1 can be employed with anyone of system 200, system 300, system 400, system 500, system 600 and related components of FIG. 2, FIG. 3, FIG. 4, FIG. 5, and FIG. 6, respectively, and any combination. The features depicted in FIG. 4 will be described but any feature not specifically described with reference to FIG. 4 can be associated with the similarly numbered feature in any one of the other Figures. The specific combination or organization of the numbered features in FIG. 4 is not meant to limit the description to this specific orientation. Instead, FIG. 4 is an exemplary illustration meant to show one possible embodiment of the system described in the present disclosure.

According to the embodiment as shown in FIG. 4, plant growth region 440 is depicted to include fluid reservoir 441. The water level 443 is shown near the top of fluid reservoir 441. In the embodiment as shown, the fluid reservoir 441 is enclosed by fluid reservoir walls 445, which contain the water in the fluid reservoir 441. One or more plan support structures 442 are depicted as floating on the top of the water 443. The plant support 442 has been described above and can be made of any material configured to grow plants 444. The plant support 442 can be, for example, floats and/or rafts made of various materials that are configured to float on water. Illustrative materials include, but are not limited to, polystyrenes, expanded polystyrenes (e.g., Styrofoam), polypropylenes, expanded polypropylenes, and other types of plastics and/or polymeric materials. The floats and/or rafts can be molded, blow molded, or otherwise formed into various shapes capable of holding plants and floating on water. In some embodiments, the floats and/or rafts can be configured to move about the one or more reservoirs during the cultivation cycle.

In addition, in certain embodiments the plant support 442 can be configured to aid in the removal of the top layer of water and/or floating material from the plant growth region through a skimming outlet 407, which is a part of a skimming system. For example, the plant support 442 can be configured with hydrophobic edges, and/or wedge shaped edges, which aid in the removal of the top layer of water. In some embodiments the plant supports 442 include a plurality of plant supports 442 and can move freely throughout the plant growth region 440. In some embodiments the flow of water from the water inlet 406 pushes the water and creates a current that move the plant supports 442 toward the skimming outlet 407, and further aids in the removal of the top layer of water 443 from the reservoir. In some embodiments, the plant supports 442 can be tethered to a motorized conveyor system to move the plant supports 442 in a specific pattern and at specific speeds throughout the plant growth region. In other embodiments the plant supports 442 can themselves be motorized to propel through the water in a specific pattern and at a specific speed. According to certain embodiments, the plant supports 442 can be controlled via a water management computer (not depicted) to control their speed and the pattern in which they move through the plant growth region.

According to certain embodiments, the skimming outlet 407 can be configured to be adjustable so that the top of the outlet can be set to any depth from the top of the water 443, including but not limited to, 1 cm, 2 cm, 3 cm, 4 cm, 5 cm, 6 cm, 7 cm, 8 cm, 9 cm, or 10 cm. In certain embodiments, the skimming outlet 407 can be controlled automatically by using a water management computer, or it can be adjusted manually. In some embodiments, the top of the skimming outlet 407 can be set to a closed configuration or it can be raised to any level above the water 443 so that no water is removed from the fluid reservoir 441 through the skimming outlet, and can be set to an open configuration to facilitate the removal of water. In some embodiments, the aperture or opening of the skimming outlet 407 can also be adjusted to allow more or less water to flow out of the fluid reservoir as desired.

In addition, according to certain embodiments, the skimming outlet is fluidly coupled to a filter 450. In some embodiments, the filter 450 is configured to filter out large particulates and floating debris. In some embodiments, the filter 450 is configured to filter out small particles and may be configured with an active carbon filter. In some embodiments, the filter is a nanofiltration or microfiltration system. The filter 450 is then fluidly coupled to the water management unit 410 through fluid conduit 409.

The fluid reservoir 441 may, in some embodiments, include a second outlet 408 which can be situated at any depth in the reservoir including, but not limited to, the bottom of the reservoir 441. This second outlet 408 is directly coupled to the water management unit 410 and does not pass through the filter 450. In some embodiments, the second outlet 408 can be closed to prevent any water from leaving the fluid reservoir 441 through the second outlet 408.

Similar structures are present in FIG. 5 as have been described with reference to the other figures, in particular FIG. 4. In addition to the elements depicted in the other figures, FIG. 5 depicts the use of a sanitizing system 580. In some embodiments, the sanitizing system 580 is configured to treat the plant growth region 540, such as by providing the sanitizing system 580 above the fluid reservoir 541, or by otherwise configuring the sanitizing system 580 so as to treat fluid within the fluid reservoir. In some embodiments, the sanitizing system 582 is in the water management unit 510. In yet another embodiment, the sanitizing systems 580 and 582 are both a part of system 500. In still another embodiment, the sanitizing system is connected to the bioreactor 530 (not depicted). According to certain embodiments, the sanitizing system is configured to reduce plant exudates or contaminants in the system. In some embodiments, the sanitizing system includes the use of ultraviolet light, such that the UV light is exposed to the water. According to yet another embodiment, the sanitizing system provides any of ozone, H₂O₂, and/or other materials to facilitate the removal of plant exudates or contaminants in the system. In one embodiment, one or more sanitizing systems may be used to reduce plant exudates at different areas of the system. For example, according to one embodiment, a UV-based sanitizing system may be used to treat water before it is introduced into the fluid reservoir, and/or to treat water that has been removed from the fluid reservoir, such as for example via a skimming system as described elsewhere herein. According to yet another embodiment, an ozone-based sanitizing system may be used to treat water in the fluid reservoir by introducing ozone into the fluid reservoir. Other combinations of UV, ozone and/or hydrogen peroxide-based sanitizing systems may also be used to treat water circulating in the system. In one embodiment, the sanitizing system 580 provided to treat the plant growth region may be configured to dose ozone into the plant growth region, such a via a gas line on the bottom of the fluid reservoir that provides a controlled release of ozone into the plant growth region. According to a further aspect, the amount of ozone released into the plant growth region 540 can be monitored by a sensor positioned in the plant growth region, and adjusted according to an amount of ozone that is detected.

In some embodiments, the system includes an outflow pump, or a skimming pump 547. The pump can be a skimming pump 547, or any other flow control device to remove the top layer of water from the fluid reservoir. The pumping system can be set at any depth in the fluid reservoir and can either be manually controlled or controlled automatically. In some embodiments, the skimming system pump can be controlled by the water management computer. In some embodiments, the skimming system pump can be set to suck water out of the fluid reservoir. In some embodiments the skimming system pump can be set to expel water out of the fluid reservoir.

The system 600 depicted in FIG. 6 shows another embodiment of the skimming system using an overflow gutter 601. According to certain embodiments, the overflow gutter can be configured to allow a certain volume of water to flow out of the fluid reservoir 641. In some embodiments, the top end of fluid reservoir wall 645 can be set to a predetermined depth to allow any water volume in the reservoir in excess to flow out of the reservoir. In some embodiments, the height of the fluid reservoir wall 645 can be adjusted either manually or with the aid of a computer, such as the water management computer (not depicted). In some embodiments, the fluid reservoir wall 645 can be raised so that no flow of water out of the fluid reservoir flows out of the overflow gutter 601. In some embodiments, the overflow gutter 601 directs water to a collection region 690. According to certain embodiments, from collection region 690, water can either be removed from the system 600 through collection region outlet 691, or the water can be flowed through conduit 692 into a filter 650, before passing through another outflow conduit 609 and back into the water management unit 610. In some embodiments, such as the one depicted in FIG. 6, the fluid reservoir 641 also includes a second outlet 608. Just as described with respect to fluid outlets 408 in FIGS. 4 and 508 in FIG. 5 this outlet can be set at any depth in the water. In some embodiments, the second outlet 608 can be adjusted so that the aperture is closed or made smaller to reduce the flow of water from the fluid reservoir 641.

In some embodiments, control of flow through the two outflow components, the skimming outlet and the second outlet as described above would allow for all of the water to flow through the filter or partial flow through the filter.

In some embodiments, the plant supports, such as plant floats, are configured to circulate from an initial region distal to the skimming outlet when first introduced into the fluid reservoir, and are circulated to a final region proximate the skimming outlet after a predetermined growing period spent in the fluid reservoir. The plant float circulation, in some embodiments, is configured, to move toward the skimming outlet and to displace a volume of water towards and into the skimming outlet.

According to yet another embodiment, as depicted in FIG. 7, the system 700 can include a first transport gutter 748 used to transport plant supports (not depicted) to the plant growth region 740. In certain embodiments, a flow of water 747 pushes the plant supports in this direction to then be transferred from the first transport gutter 748 to the plant growth region 740 and into any of a plurality of water reservoirs 741. According to the embodiment as shown, the water reservoir also contains at least one water inlet 706 and one or more skimming outlets 707 that are all in fluid communication with a water collection system 790. In another embodiment, the system 700 also includes a second transport gutter 749 to transport plant supports away from the water reservoir 741, such as those plant supports that have been moved across the plant growth region during the plant growth process (e.g. in a direction from the first transport gutter 748 toward the skimming outflow 707). According to certain embodiments, the second transport gutter 749 uses a flow of water to transport the plant supports to a harvest area, the plants having grown and matured during their time in the plant growth region. According to certain embodiments, the duration of time that the plant supports spend in the plant growth region can vary according to the desired growing time, such as from days, to weeks to months, with the plant supports being moved across the reservoir, either manually or automatically, from the plant introduction end adjacent the first transport gutter, to the plant removal end adjacent the second transport gutter. According to certain embodiments, new plant supports containing new growth plants can be continuously or intermittently added from the first transport gutter to replace those plant supports having fully grown or matured plants and that are removed via the second transport gutter.

According to the embodiment as depicted in FIG. 7, the water in the reservoir 741 flows out of the plant growth region 740 through a skimming outlet 707. According to certain embodiments, the water then flows into a water collection region 790. According to yet further embodiments, the water then passes through conduit 792 to a filter 750. As has been discussed above with reference to other figures, the filter 750 can be carbon, nano, paper, or other appropriate water filtration systems. From the filter 750, in certain embodiments, the water flows through conduit 709 to a water management unit 710. In the embodiment as depicted here, the water is exposed to a sanitizing system 780, such as ultraviolet light. According to certain embodiments, as has been discussed with reference to the other figures, the water can be measured and/or treated to conform with certain parameters in the water management unit 710. As will be discussed in more detail below, the water treatment provided in the water management unit can also include the addition of an oxidizing compound in certain embodiments. In the embodiment as depicted in FIG. 7, the water then flows from the water management unit 710 through conduit 704 into the bioreactor 730. According to certain embodiments, the water can also flow from the water management unit directly back into the fluid reservoir 741 through inlet pipe 706. In some embodiments, the water coming from the bioreactor 730 flows through conduit 703 and joins inlet pipe 706 before entering the fluid reservoir 741.

In some embodiments, an oxidative composition is provided to the system. An oxidative composition, or an oxidizing agent, may also be known as an oxidizer. These terms are interchangeable in the present disclosure and mean any composition that has the ability to oxidize other substances. Common oxidizing agents include oxygen and hydrogen peroxide. Non-limiting examples of compositions that may act as oxidizing agents include, but are not limited to, oxygen, ozone, fluorine, chorine, bromine, iodine, hypochlorite, chorate, nitric acid, sulfur dioxide, chromate, permanganate, manganite, and hydrogen peroxide. According to certain embodiments, the oxidative composition may also be one that facilitates the growth and production of food quality plants. In some embodiments, an oxidative compound is one with a negative redox potential as is measured in Volts, with the standard hydrogen electrode being the reference from which all standard redox potentials are determined, as understood by those of ordinary skill in the art. In some embodiments, an oxidative compound is provided with a redox potential that is lower than that of hydrogen peroxide at −1.78V (as measured relative to the standard hydrogen reference electrode). In some embodiments, the system includes an oxidative compound with a redox potential that is lower than that of permanganate (MnO4) at −1.68V. The following table of oxidizing agents is provided for convenience showing redox potentials in Volts.

TABLE 1

| | | |
|---|---|---|
| Fluor | F2 | −3.05 |
| Ferrate VI | FeO₄ ²⁻ | −2.20 |
| Ferrate V | FeO₄ − | −2.09 |
| Ozone | O₃ | −2.08 |
| Hydrogen peroxide | H₂O₂ | −1.78 |
| Permanganate | MnO₄ ²⁻ | −1.68 |
| Hypochlorite | ClO ₋ | −1.48 |
| Perchlorate | ClO₄ − | −1.39 |
| Chlorine | Cl₂ | −1.36 |
| Dissolved Oxygen | O₂ | −1.23 |
| Chlorine Dioxide | ClO₂ | −0.95 |

In some embodiments, the oxidative compound has a redox potential that is at least 10% lower, or more negative as measured in Volts, than that of hydrogen peroxide. In some embodiments, the oxidative compound has a redox potential that is at least 10% lower, more negative as measured in Volts, than that of permanganate. In some embodiments, the oxidative compound has a redox potential that is at least 5% lower than that of hydrogen peroxide. In some embodiments, the oxidative compound has a redox potential that is at least 1% lower than that of hydrogen peroxide. In some embodiments, the oxidizing compound is any compound that can function to provide plant nutrition. In some embodiments, the oxidizing agent can be added once to the system at various intervals, or continuously, and/or in response to detection of a parameter that indicates the need for adjustment of levels of the oxidizing agent.

In some embodiments, the system includes a compound that causes coagulation and flocculation of plant exudate or a contaminant. In some embodiments, the compound causes coagulation and flocculation of plant exudate or a contaminant at a pH range between 4.5 and 7.5. In some embodiments, the oxidative compound causes coagulation and flocculation of plant exudate or a contaminant. In some embodiments, the oxidative compound causes coagulation and flocculation of plant exudate or a contaminant at a pH range between 4.5 and 7.5. In some embodiments, a rate of introduction of a compound that is oxidative and/or that causes coagulation and flocculation into the system may be a rate of at least 1 ml/m³ per day, such as a rate of introduction in a range of from 1 to 100 ml/m³ per day, and even at a rate of 5 to 50 ml/m³ per day, such as a rate of 10-25 ml/m³ per day.

Methods of using the above-identified systems are also disclosed herein. In particular, it is contemplated that any of the components, principles, and/or embodiments discussed above may be utilized in either a hydroponic system or a method of using the same.

It will be appreciated that any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may include only a portion of the steps described in a more detailed method.

References to approximations are made throughout this specification, such as by use of the terms “about.” For each such reference, it is to be understood that, in some embodiments, the value, feature, or characteristic may be specified without approximation. For example, where qualifiers such as “about” or “substantially” are used, these terms include within their scope the qualified words in the absence of their qualifiers. All disclosed ranges also include both endpoints. Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description.

Without further elaboration, it is believed that one skilled in the art can use the preceding description to utilize the invention to its fullest extent. The claims and embodiments disclosed herein are to be construed as merely illustrative and exemplary, and not a limitation of the scope of the present disclosure in any way. It will be apparent to those having ordinary skill in the art, with the aid of the present disclosure, that changes may be made to the details of the above-described embodiments without departing from the underlying principles of the disclosure herein. In other words, various modifications and improvements of the embodiments specifically disclosed in the description above are within the scope of the appended claims. The scope of the invention is therefore defined by the following claims and their equivalents.

1. A system for hydroponic plant cultivation, comprising:
a water management unit to manage water circulating in the system; and
one or more plant growth regions comprising a plurality of plant supports provided in contact with a fluid reservoir containing water and nutrients, the one or more plant growth regions being in fluid communication with the water management unit;
wherein the water management unit, and one or more plant growth regions, are in fluid communication together to allow water to circulate through the system; and
a skimming system comprising a skimming outlet, wherein the skimming system is configured to remove a top layer of water from the fluid reservoir of at least one of the one or more plant growth regions via the skimming outlet,
wherein the system is configured for cultivating plants on the plant support, wherein the plants comprise herbs, greens, or vegetables that can be grown indoors and that release an exudate that is detrimental to plant growth into the fluid reservoir.

2. The system of claim 1, further comprising a bioreactor, wherein the bioreactor is configured to accept both organic and non-organic nitrogen feed sources, and wherein the bioreactor is in fluid communication with one or more of the water management unit and the one or more plant growth regions.

3. The system of claim 1, wherein fluid communication between the water management unit and the one or more plant growth regions is provided through one or more flow conduits connecting the water management unit to the one or more plant growth regions.

4. The system of claim 2, wherein the bioreactor is in fluid communication with the water management unit through one or more flow conduits connecting the water management unit to the bioreactor, and one or more of the bioreactor and the water management unit is in fluid communication with the one or more plant growth regions through flow conduits, and wherein the system is configured to circulate water through one or more of the water management unit and the bioreactor into the one or more plant growth regions.

5. The system of claim 2, wherein fluid communication between the water management unit and the one or more plant growth regions is provided through one or more flow conduits connecting the water management unit to the one or more plant growth regions, and wherein the bioreactor is in fluid communication with the water management unit through one or more flow conduits connecting the water management unit to the bioreactor, and wherein the system is configured to circulate water from the water management unit and bypassing the bioreactor into the one or more plant growth regions.

6. The system of claim 1, wherein the skimming system removes the top layer of water that comprises material floating on the surface of the water and at least the top 1 cm of water in the fluid reservoir.

7. The system of claim 1, wherein the system further comprises a nitrogen feed source coupled to one or more of the bioreactor, the water management unit, and the reservoir.

8. The system of claim 7, wherein the nitrogen feed source comprises a plant-based feed source, and wherein the bioreactor is configured to convert the nitrogen feed source into nitrogen compounds that facilitate growth of the plants.

9. The system of claim 2, wherein the system is an organic hydroponic plant cultivation system.

10. The system of claim 7, wherein the plant based feed source is hydrolyzed plant material.

11. The system of claim 1, wherein the system is configured to introduce one or more of bacteria, fungi, or other microorganisms into the water circulating through the system.

12. The system of claim 11, wherein the one or more of bacteria, fungi, or other microorganisms move freely throughout the reservoir(s) of the one or more plant growth regions.

13. The system of claim 11, wherein the bacteria, fungi, or other microorganisms sequentially oxidize nitrogen into nitrate and nitrite.

14. The system of claim 2, wherein the bioreactor comprises one or more of bacteria, fungi and other microorganisms, and the system is configured to permit a flow of one or more of the bacteria, fungi, and other microorganisms from the bioreactor into one or more of the water management unit and the one or more plant growing regions.

15. The system of claim 14, wherein the bacteria, fungi, or other microorganisms sequentially oxidize nitrogen into nitrate and nitrite.

16. The system of claim 14, wherein the bioreactor comprises a substrate upon which the one or more of bacteria, fungi, or other microorganisms can reside, and optionally wherein the substrate upon which the one or more of bacteria, fungi, or other microorganisms can reside is further provided in one or more of the plant growth regions.

17. The system of claim 1, wherein the system is configured for cultivating at least one of spinach and cilantro.

18. The system of claim 1, further comprising an aeration system, wherein the aeration system is configured to deliver air into water being circulated in the system.

19. The system of claim 1, wherein one or more parameters of the water are measured by the water management unit and the one or more parameters are adjusted in the water management unit if the one or more parameters are changed beyond a predetermined level as the water circulates through the system.

20. The system of claim 19, wherein the one or more parameters are selected from pH, temperature, oxygen level, nutrient level, oxygen reduction potential, light transmission, and adenosine triphosphate (ATP).

21. The system of claim 1, further comprising a source of plasma activated water.

22. The system of claim 18, further comprising a source of nanobubbles.

23. The system of claim 3, wherein at least one of the one or more plant growth regions comprises a water inlet that is in fluid communication with the water management unit via the one or more flow conduits.

24. The system of claim 23, wherein the water inlet is located at or towards the bottom of the fluid reservoir.

25. The system of claim 23, wherein water introduced into the one or more plant growth regions through the water inlet circulates water in the direction of the skimming outlet.

26. The system of claim 23, wherein the skimming outlet is located at a higher position in the fluid reservoir in the vertical direction than the water inlet.

27. The system of claim 26, wherein a direction of water flow in the reservoir is from the bottom of the reservoir towards the top of the water reservoir.

28. The system of claim 1, wherein the skimming outlet removes the top layer of water from the fluid reservoir of the one or more plant growth regions into a collection system.

29. The system of claim 28, wherein the skimming outlet comprises a tube, wherein a top opening of the tube is configured to be submerged in the fluid reservoir at least 3 cm from the top surface of the water in the fluid reservoir.

30. The system of claim 29, wherein the top opening of the tube is configured to be continuously submerged in the fluid reservoir.

31. The system of claim 29, wherein a depth of the top opening of the tube in the fluid reservoir is adjustable.

32. The system of claim 28, wherein the skimming outlet comprises an overflow system comprising a trench that runs along at least one edge of the fluid reservoir, and wherein the trench removes the top layer of water from the fluid reservoir by overflow of the water from the fluid reservoir.

33. The system of claim 1, wherein the fluid reservoir is filled to no more than a predetermined level of water as measured in the vertical direction, and wherein the skimming outlet is configured to remove a top layer of water from the fluid reservoir when the level of water of the fluid reservoir in the vertical direction exceeds the predetermined level.

34. The system of claim 1, further comprising a second outlet in at least one reservoir of the one or more plant growth regions, the second outlet being configured to flow water out of the at least one reservoir;
wherein water removed through the skimming outlet is circulated through a filter before being routed through the water management unit; and,
wherein water removed through the second outlet is routed through the water management unit and back into the one or more plant growth regions without being circulated through a filter.

35. The system of claim 1, wherein the skimming system is configured to actively pump the top layer of water from the at least one fluid reservoir of the one or more plant growth regions.

36. The system of claim 1, wherein the skimming system passively removes the top layer of water from the at least one fluid reservoir of the one or more plant growth regions.

37. The system of claim 1, wherein the skimming system comprises a pumping system configured to remove the top layer of water from the at least one fluid reservoir of the one or more plant growth regions by pumping the top layer of water through the skimming outlet into a collection region in fluid communication with at least one of the one or more plant growth regions.

38. The system of claim 1, wherein the fluid reservoir is a deep-water reservoir, wherein the deep-water reservoir is sufficiently deep to permit immersion of a majority of the root systems of the plants in the water.

39. The system of claim 38, wherein the deep-water reservoir is configured to hold water that is at least 3 cm in depth therein.

40. The system of claim 38, wherein the deep-water reservoir is configured to hold water that is at least 5 cm in depth therein.

41. The system of claim 38, wherein the deep-water reservoir is configured to hold water that is at least 10 cm in depth therein.

42. The system of claim 38, wherein the deep-water reservoir is configured to hold water that is at least 15 cm in depth therein.

43. The system of claim 38, wherein the deep-water reservoir is configured to hold water that is no more than 100 cm in depth therein.

44. The system of claim 38, wherein the deep-water reservoir is configured to hold water that is no more than 75 cm in depth therein.

45. The system of claim 38, wherein the deep-water reservoir is configured to hold water that is no more than 60 cm in depth therein.

46. The system of claim 38, wherein the deep-water reservoir is configured to hold water that is between 3 cm and 50 cm in depth therein.

47. The system of claim 38, wherein the deep-water reservoir is configured to hold water that is between 5 cm and 45 cm in depth therein.

48. The system of claim 38, wherein the deep-water reservoir is configured to hold water that is between 20 cm and 35 cm in depth therein.

49. The system of claim 38, wherein the deep-water reservoir is configured to hold water that is between 25 cm and 30 cm in depth therein.

50. The system of claim 38, wherein the system comprises a plurality of plant growth floats configured to be circulated about any of the one or more plant growth regions.

51. The system of claim 50, wherein the plant growth floats are configured to push the top layer of water as the plant growth floats are circulated about the one or more plant growth regions.

52. The system of claim 50, wherein the plant growth floats are configured to be circulated by manual or automated pushing or pulling of the plant growth floats.

53. The system of claim 50, wherein the plant growth float is motorized to facilitate circulation about the one or more plant growth regions.

54. The system of claim 51, wherein the edges of the plant growth floats that are configured to be placed in contact with the top layer of water are configured to push the top layer of water toward the skimming outlet.

55. The system of claim 51, wherein the plant growth floats are configured to displace a volume of water towards the skimming outlet as they are circulated in the one or more plant growth regions.

56. The system of claim 51, wherein the fluid reservoir is configured to accommodate a plurality of plant growth floats, and wherein the plant growth floats are circulated from an initial region distal to the skimming outlet when first introduced into the fluid reservoir, and are circulated to a final region proximate the skimming outlet after a predetermined growing period spent in the fluid reservoir, and wherein circulation of the plant growth floats towards the skimming outlet displaces a volume of water towards and into the skimming outlet.

57. The system of claim 1, further comprising a filtering system, wherein the filtering system is in fluid communication with at least one of the one or more plant growth regions, and wherein the filtering system is configured to filter water flowing through the system for hydroponic plant cultivation.

58. The system of claim 48, wherein the filtering system is configured to filter water removed from at least one of the one or more plant growth regions through the skimming outlet through an active carbon filter to eliminate larger organic molecules.

59. The system of claim 48, wherein the filtering system is configured to filter water removed from the one or more plant growth regions through the skimming outlet through a nanofiltration or microfiltration system.

60. The system of claim 1, further comprising a flow rate controller configured to adjust a volume percent of water cycled through the system.

61. The system of claim 60, wherein the flow rate controller is configured to re-circulate at least 80% of the volume of water present in the system every 4 hours to every 10 days.

62. The system of claim 61, wherein the flow rate controller is configured to re-circulate at least 85% of the volume of water present in the system every 4 hours to every 10 days

63. The system of claim 62, wherein the flow rate controller is configured to re-circulate at least 90% of the volume of water present in the system every 4 hours to every 10 days.

64. The system of claim 63, wherein the flow rate controller is configured to re-circulate at least 95% of the volume of water present in the system every 4 hours to every 10 days.

65. The system of claim 63, wherein the flow rate controller is configured to re-circulate 100% of the volume of water present in the system every 4 hours to every 10 days.

66. The system of claim 1, further comprising an oxidative composition, wherein the oxidative composition comprises an oxidative compound having a redox potential that is lower than that of hydrogen peroxide as measured relative to a reference potential.

67. The system of claim 66, wherein the oxidative composition has a redox potential that is less than −1.78 Volts.

68. The system of claim 66, wherein the oxidative composition has a redox potential that is less than −1.68 Volts.

69. The system of claim 66, wherein the oxidative composition has a redox potential that is at least 10% lower, more negative as measured in Volts, than that of hydrogen peroxide (or −1.78 Volts).

70. The system of claim 66, wherein the oxidative composition has a redox potential that is at least 10% lower, more negative as measured in Volts, than that of permanganate (or −1.68 Volts).

71. The system of claim 66, wherein the oxidative composition causes coagulation and flocculation of a plant exudate or a contaminant.

72. The system of claim 71, wherein the oxidative composition causes coagulation or flocculation of the plant exudate or the contaminant at a pH range between 4.5 to 7.5.

73. The system of claim 1, further comprising a composition that causes coagulation or flocculation of a plant exudate or a contaminant.

74. The system of claim 66, wherein the system is configured to allow for introduction of the oxidative composition to the system at rate of introduction in a range of from 1 to 100 ml/m³ per day, from 5 to 50 ml/m³ per day, and/or from 10-25 ml/m³ per day.

75. The system of claim 1, further comprising a sanitizing system, wherein the sanitizing system reduces a plant exudate or a contaminant in the system.

76. The system of claim 75, wherein the sanitizing system is configured to expose water in the system to any of ultraviolet light, ozone, and hydrogen peroxide.

77. The system of claim 75, wherein the sanitizing system is configured to expose water in one or more of the plant growth regions to any of ultraviolet light, ozone, and hydrogen peroxide.

78. The system of claim 75, wherein the sanitizing system is configured to expose water in the water management unit to any of ultraviolet light, ozone, and hydrogen peroxide.

79. A method for hydroponic plant cultivation, comprising:
circulating water through a system comprising a water management unit and one or more plant growth regions all in fluid communication together;
measuring one or more parameters of the water as the water circulates through the system;
adjusting the one or more parameters of the water with the water management unit based on the measurement;
cultivating one or more plants in the one or more plant growth regions, wherein the one or more plants comprise a plant support provided in contact with a fluid reservoir containing water, and wherein the one or more plants comprise herbs, greens, or vegetables that can be grown indoors and that release an exudate that is detrimental to plant growth into the fluid reservoir, and
skimming a top layer of water from the fluid reservoir of the one or more plant growth regions with a skimming system, wherein the skimming system removes the top layer of water from the fluid reservoir via a skimming outlet.

80. The method of claim 79, wherein the system further comprises a bioreactor, wherein the bioreactor is configured to accept both organic and non-organic nitrogen feed sources, and wherein the bioreactor is in fluid communication with the water management unit and the one or more plant growth regions.

81. The method of claim 79, wherein fluid communication between the water management unit and the one or more plant growth regions is provided through one or more flow conduits connecting the water management unit to the one or more plant growth regions.

82. The method of claim 80, wherein the bioreactor is in fluid communication with the water management unit through one or more flow conduits connecting the water management unit to the bioreactor, and one or more of the bioreactor and the water management unit is in fluid communication with the one or more plant growth regions through flow conduits, and wherein the system is configured to circulate water through one or more of the water management unit and the bioreactor into the one or more plant growth regions.

83. The method of claim 80, wherein fluid communication between the water management unit and the one or more plant growth regions is provided through one or more flow conduits connecting the water management unit to the one or more plant growth regions, and wherein the bioreactor is in fluid communication with the water management unit through one or more flow conduits connecting the water management unit to the bioreactor, and wherein the system is configured to circulate water from the water management unit and bypassing the bioreactor into the one or more plant growth regions.

84. The method of claim 79, wherein the top layer of water comprises material floating on the surface of the water and at least the top 1 cm of water in the fluid reservoir.

85. The method of claim 79, further comprising: delivering a nitrogen feed source to one or more of the bioreactor, the water management unit, and the reservoir.

86. The method of claim 85, wherein the nitrogen feed source comprises a plant-based feed source, and wherein the bioreactor is configured to convert the nitrogen feed source into nitrogen compounds that facilitate growth of the plants.

87. The method of claim 79, wherein the method is an organic hydroponic plant cultivation method.

88. The method of claim 86, wherein the plant based feed source is hydrolyzed plant material.

89. The method of claim 79, further comprising introducing one or more of bacteria, fungi, or other microorganisms into the water circulating through the system.

90. The method of claim 89, wherein the one or more bacteria, fungi, or other microorganisms move freely throughout the one or more plant growth regions.

91. The method of claim 89, wherein the bacteria, fungi, or other microorganisms sequentially oxidize nitrogen into nitrate and nitrite.

92. The method of claim 80, wherein the bioreactor comprises one or more of bacteria, fungi and other microorganisms, and the system is configured to permit a flow of one or more of the bacteria, fungi, and other microorganisms from the bioreactor into one or more of the water management unit and the one or more plant growing regions.

93. The method of claim 92, wherein the bioreactor comprises a substrate upon which the one or more of bacteria, fungi, or other microorganisms reside, and optionally wherein the substrate upon which the one or more of bacteria, fungi, or other microorganisms can reside is further provided in one or more of the plant growth regions.

94. The method of claim 89, wherein the bacteria, fungi, or other microorganisms sequentially oxidize nitrogen into nitrate and nitrite.

95. The method of claim 79, wherein the one or more plants comprise at least one of spinach and cilantro.

96. The method of claim 79, further comprising delivering gas into the system through an aeration system.

97. The method of claim 79, wherein one or more parameters of the water are measured by the water management unit and the one or more parameters are adjusted in the water management unit if the one or more parameters are changed beyond a predetermined level as the water circulates through the system.

98. The method of claim 97, wherein the one or more parameters are selected from pH, temperature, oxygen level, nutrient level, oxygen reduction potential, light transmission, and adenosine triphosphate (ATP).

99. The method of claim 79, further comprising delivering a source of plasma activated water.

100. The method of claim 79, further comprising delivering a source of nanobubbles.

101. The method of claim 81, further comprising delivering water to the one or more plant growth regions through a water inlet that is in fluid communication with the water management unit via the plurality of flow conduits.

102. The method of claim 101, wherein the water inlet is located at or towards the bottom of the fluid reservoir.

103. The method of claim 101, wherein the water delivered into the one or more plant growth regions through the water inlet circulates water in the direction of the skimming outlet.

104. The method of claim 101, wherein the skimming outlet is located at a higher position in the fluid reservoir in the vertical direction than the water inlet.

105. The method of claim 104, wherein a direction of water flow in the reservoir is from the bottom of the reservoir towards the top of the water reservoir.

106. The method of claim 79, wherein the skimming outlet removes the top layer of water from the fluid reservoir of the one or more plant growth regions into a collection system.

107. The method of claim 106, wherein the skimming outlet comprises a tube, wherein a top opening of the tube is submerged in the fluid reservoir at least 3 cm from the top surface of the water in the fluid reservoir.

108. The method of claim 107, wherein the top opening of the tube is continuously submerged in the fluid reservoir.

109. The method of claim 107, wherein a depth of the top opening of the tube is adjustable.

110. The method of claim 79, wherein the skimming outlet comprises an overflow system comprising a trench that runs along at least one edge of the fluid reservoir, and wherein the trench removes the top layer of water from the fluid reservoir by overflow of the water from the fluid reservoir.

111. The method of claim 79, wherein the fluid reservoir is filled to no more than a predetermined level of water as measured in the vertical direction, and wherein the skimming outlet is configured to remove a top layer of water from the fluid reservoir when the level of water of the fluid reservoir in the vertical direction exceeds the predetermined level

112. The method of claim 79, further comprising a second outlet;
wherein water removed through the skimming outlet is circulated through a filter before being routed through the water management unit; and,
wherein water removed through the second outlet is routed through the water management unit and back into the one or more plant growth regions without being circulated through a filter.

113. The method of claim 79, wherein the skimming system is configured to actively pump the top layer of water from the fluid reservoir of the one or more plant growth regions.

114. The method of claim 79, wherein the skimming system passively removes the top layer of water from the fluid reservoir of the one or more plant growth regions.

115. The method of claim 79, wherein the skimming system comprises a pumping system configured to remove the top layer of water from the fluid reservoir of the one or more plant growth regions by pumping the top layer of water through the skimming outlet into a collection region in fluid communication with the at least one of the one or more plant growth regions.

116. The method of claim 79, wherein the one or more plant growth regions is a deep-water reservoir, and wherein the fluid reservoir is a deep-water reservoir, wherein the deep-water reservoir is sufficiently deep to permit immersion of a majority of the root systems of the plants in the water.

117. The method of claim 116, wherein the deep-water reservoir is configured to hold water that is at least 3 cm in depth therein.

118. The method of claim 116, wherein the deep-water reservoir is configured to holdwater that is at least 5 cm in depth therein.

119. The method of claim 116, wherein the deep-water reservoir is configured to hold water that is at least 10 cm in depth therein.

120. The method of claim 116, wherein the deep-water reservoir is configured to hold water that is at least 15 cm in depth therein.

121. The method of claim 116, wherein the deep-water reservoir is configured to hold water that is no more than 100 cm in depth therein.

122. The method of claim 116, wherein the deep-water reservoir is configured to hold water that is no more than 75 cm in depth therein.

123. The method of claim 116, wherein the deep-water reservoir is configured to hold water that is no more than 60 cm in depth therein.

124. The method of claim 116, wherein the deep-water reservoir is configured to hold water that is between 3 cm and 50 cm in depth therein.

125. The method of claim 116, wherein the deep-water reservoir is configured to hold water that is between 5 cm and 45 cm in depth therein.

126. The method of claim 116, wherein the deep-water reservoir is configured to hold water that is between 20 cm and 35 cm in depth therein.

127. The method of claim 116, wherein the deep-water reservoir is configured to hold water that is between 25 cm and 30 cm in depth therein.

128. The method of claim 79, further comprising; adding nanobubbles into the system.

129. The method of claim 79, wherein the one or more plants in the one or more plant growth regions is disposed on at least one of a plurality of plant growth floats in the one or more plant growth regions.

130. The method of claim 129, wherein the plant growth floats are configured to be circulated by manual or automated pushing or pulling of the plant growth floats, wherein the circulation is about the one or more plant growth regions, wherein the circulation of the plurality of plant growth floats can be limited to one plant growth region, or the circulation of the plurality of plant growth floats can circulation between one or more plant growth regions.

131. The method of claim 129, wherein the plant growth float is motorized to facilitate circulation about the one or more plant growth regions.

132. The method of claim 130, wherein the edges of the plant growth floats in contact with the top layer of water are configured to push the top layer of water toward the skimming outlet.

133. The method of claim 130, wherein the plant growth floats are configured to displace a volume of water towards the skimming outlet as they are circulated in the one or more plant growth regions.

134. The method of claim 130, wherein the fluid reservoir is configured to accommodate a plurality of plant growth floats, and wherein the plant growth floats are circulated from an initial region distal to the skimming outlet when first introduced into the fluid reservoir, and are circulated to a final region proximate the skimming outlet after a predetermined growing period spent in the fluid reservoir, and wherein circulation of the plant growth floats towards the skimming outlet displaces a volume of water towards and into the skimming outlet.

135. The method of claim 79, further comprising a filtering system, wherein the filtering system is in fluid communication with at least the one or more plant growth regions, and wherein the filtering system is configured to filter water flowing through the system for hydroponic plant cultivation.

136. The method of claim 112, wherein the filtering system is configured to filter water removed from at least one of the one or more plant growth regions through the skimming outlet through an active carbon filter to eliminate larger organic molecules.

137. The method of claim 112, wherein the filtering system is configured to filter water removed from the one or more plant growth regions through skimming outlet through a nanofiltration or microfiltration system.

138. The method of claim 79, further comprising a flow rate controller, wherein the percent of fluid cycled through the system can be adjusted.

139. The method of claim 79, wherein the flow rate controller is configured to re-circulate at least 80% of the volume of water present in the system every 4 hours to every 10 days.

140. The method of claim 139, wherein the flow rate controller is configured to re-circulate at least 85% of the volume of water present in the system every 4 hours to every days.

141. The method of claim 140, wherein the flow rate controller is configured to re-circulate at least 90% of the volume of water present in the system every 4 hours to every days.

142. The method of claim 141, wherein the flow rate controller is configured to re-circulate at least 95% of the volume of water present in the system every 4 hours to every days.

143. The method of claim 142, wherein the flow rate controller is configured to re-circulate 100% of the volume of water present in the system every 4 hours to every 10 days.

144. The method of claim 79, further comprising an oxidative composition, wherein the oxidative composition comprises an oxidative composition having a redox potential that is lower than that of hydrogen peroxide as measured to a reference potential.

145. The method of claim 144, wherein the oxidative composition has a redox potential that is less than −1.78 Volts.

146. The method of claim 144, wherein the oxidative composition has a redox potential that is less than −1.68 Volts.

147. The method of claim 144, wherein the oxidative composition has a redox potential that is at least 10% lower, more negative as measured in Volts, than that of hydrogen peroxide (or −1.78 Volts).

148. The method of claim 144, wherein the oxidative composition has a redox potential that is at least 10% lower, more negative as measured in Volts, than that of permanganate (or −1.68 Volts).

149. The method of claim 144, wherein the oxidative composition causes coagulation and flocculation of a plant exudate or a contaminant.

150. The method of claim 149, wherein the oxidative composition causes coagulation or flocculation of the plant exudate or the contaminant at a pH range between 4.5 to 7.5.

151. The method of claim 79, further comprising a composition that causes coagulation or flocculation of a plant exudate or a contaminant.

152. The method of claim 144, further comprising introducing the oxidative composition to the system at rate of introduction in a range of from 1 to 100 ml/m³ per day, from 5 to 50 ml/m³ per day, and/or from 10-25 ml/m³ per day.

153. The method of claim 79, further comprising a sanitizing system, wherein the sanitizing system reduces a plant exudate or a contaminant in the system.

154. The method of claim 153, wherein the sanitizing system comprises any of ultraviolet light exposure, ozone exposure, and hydrogen peroxide exposure.

155. The method of claim 153, wherein the sanitizing system is in the plant growth region, and introduces ozone into the plant growth region.

156. The method of claim 154, wherein the sanitizing system is in the water management unit.

157. A system for organic hydroponic plant cultivation, comprising:
a bioreactor;
a water management unit; and
one or more plant growth regions;
wherein the bioreactor, water management unit, and one or more plant growth regions are fluidly coupled together such that water can circulate through the system.

158. The system of claim 157, further comprising a nitrogen feed source coupled to the bioreactor.

159. The system of claim 157, wherein the bioreactor comprises one or more of bacteria, fungi, or other microorganisms.

160. The system of claim 157, wherein the bioreactor comprises a substrate upon which the one or more of bacteria, fungi, or other microorganisms can reside.

161. The system of claim 157, wherein the system is configured for cultivating at least one of lettuce, spinach, cabbage, romaine, or sprouts.

162. The system of claim 157, further comprising an aeration system coupled to the bioreactor, wherein the aeration system is configured to deliver air into the bioreactor.

163. The system of claim 157, wherein one or more parameters of the water are measured and/or adjusted as the water circulates through the system.

164. The system of claim 163, wherein the one or more parameters are selected from pH, water temperature, oxygen level, nutrient level, oxygen reduction potential, light transmission, and adenosine triphosphate (ATP).

165. The system of claim 157, further comprising a source of plasma activated water.

166. The system of claim 157, further comprising a source of nanobubbles.

167. The system of claim 157, further comprising an oxidative composition, wherein the oxidative composition comprises an oxidative composition having a redox potential that is greater than that of hydrogen peroxide as measured to a reference potential.

168. The system of claim 167, wherein the oxidative composition has a redox potential that is less than −1.78 Volts.

169. The system of claim 167, wherein the oxidative composition has a redox potential that is at least 10% higher than that of hydrogen peroxide (or −1.78 Volts).

170. The system of claim 167, wherein the highly oxidative composition causes coagulation and flocculation of a plant exudate or a contaminant.

171. The system of claim 170, wherein the highly oxidative composition causes coagulation or flocculation of the plant exudate or the contaminant at a pH range between 4.5 to 7.5.

172. The system of claim 157, further comprising a composition that causes coagulation or flocculation of a plant exudate or contaminant.

173. The system of claim 157, further comprising a sanitizing system, wherein the sanitizing system reduces a plant exudate or a contaminant in the system.

174. The system of claim 173, wherein the sanitizing system comprising any of ultraviolet light exposure, ozone exposure, and hydrogen peroxide exposure.

175. The system of claim 173, wherein the sanitizing system is in the plant growth region, and introduces ozone into the plant growth region.

176. The system of claim 174, wherein the sanitizing system is in the water management unit.

177. A method for organic hydroponic plant cultivation, comprising:
circulating water through a system comprising a bioreactor, a water management unit, and one or more plant growth regions;
measuring one or more parameters as the water circulates through the system; and
adjusting the one or more parameters based on a measurement.

178. The method of claim 177, further comprising: delivering a nitrogen feed source into the bioreactor.

179. The method of claim 177, wherein the bioreactor comprises one or more of bacteria, fungi, or other microorganisms.

180. The method of claim 179, wherein the bioreactor comprises a substrate upon which the one or more of bacteria, fungi, or other microorganisms reside.

181. The method of claim 177, further comprising: delivering the water to one or more plants disposed on floats in the one or more plant growth regions.

182. The method of claim 181, wherein the plants comprise at least one of lettuce, spinach, cabbage, romaine, or sprouts.

183. The method of claim 177, further comprising: delivering air into the bioreactor.

184. The method of claim 177, further comprising: delivering plasma activated water into the water.

185. The method of claim 177, wherein the one or more parameters are selected from pH, water temperature, oxygen level, nutrient level, oxygen reduction potential, light transmission, and adenosine triphosphate (ATP).

186. The method of claim 177, further comprising; adding nanobubbles into the water.

187. The method of claim 177, further comprising introducing an oxidative composition, wherein the oxidative composition comprises an oxidative composition having a redox potential that is greater than that of hydrogen peroxide as measured to a reference potential.

188. The system of claim 187, wherein the oxidative composition has a redox potential that is less than −1.78 Volts.

189. The system of claim 187, wherein the oxidative composition has a redox potential that is at least 10% higher than that of hydrogen peroxide (or −1.78 Volts).

190. The method of claim 187, wherein the oxidative composition causes coagulation and flocculation of a plant exudate or a contaminant.

191. The method of claim 187, wherein the oxidative composition causes coagulation and flocculation of the plant exudate or the contaminant at a pH range between 4.5 to 7.5.

192. The method of claim 177, further comprising introducing a composition that causes coagulation or flocculation of a plant exudate or a contaminant.

193. The method of claim 177, further comprising sanitizing the water with a sanitizing system that reduces a plant exudate or a contaminant in the system.

194. The method of claim 193, wherein the sanitizing system comprises any of ultraviolet light exposure, ozone exposure, and hydrogen peroxide exposure.

195. The method of claim 193, wherein the sanitizing system is in the plant growth region.

196. The method of claim 193, wherein the sanitizing system is in the water management unit.

197. A system for treating water for organic hydroponic plant cultivation, comprising:
a bioreactor coupled to a nitrogen feed source;
a water management unit; and
a source of plasma activated water;
wherein the bioreactor and the water management unit are fluidly coupled together such that water can circulate through the system.
